(19) United States
(12) Patent Application Publication
(10) Pub. No.: US 2012/0072392 A1
(43) Pub. Date: Mar. 22, 2012

(54) MANAGEMENT SYSTEM AND METHOD

(75) Inventors: Andrew Ian Crowhurst, Floreat (AU); Iain Laurence Kirkham, Fremantle (AU)

(73) Assignee: WRAYS PTY LTD, West Perth (AU)

(21) Appl. No.: 13/256,417

(22) PCT Filed: Mar. 12, 2010
(86) PCT No.: PCT/AU2010/000288

§ 371 Date: Nov. 16, 2011

(30) Foreign Application Priority Data
Mar. 13, 2009 (AU) 2009901065

(51) Int. Cl. G06F 7/00

(52) U.S. Cl. 707/608; 707/E17.008; 707/E17.01

(57) ABSTRACT

An electronic case file and document management system (1) stored on a server (13) having one or more remote terminals (14) coupled thereto, the case file and document management system comprising: a content and process application (2), a case management application (6), an email application (9) and a mail integration application (8), wherein the content and process application is operable to provide an electronic case file function (3) for storing and facilitating the display of electronic documentation relating to one or more cases, and a task management function (5) for creating and displaying data relating to tasks for the one or more cases, the remote terminals being arranged to access the electronic case file function, the task management function, the email application and the case management application for operation of the electronic case file and document management system.

### FIELD OF THE INVENTION

The present invention relates to a management system and method and particularly to an electronic case file and task management system and method particularly, although not exclusively, for use by professional services organisations such as lawyers and patent and trade mark attorneys.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

Additionally, throughout the specification, unless the context requires otherwise, the words “substantially” or “about” will be understood to not be limited to the value for the range qualified by the terms.

### BACKGROUND ART

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

There are a number of commercially available electronic case file and task management systems. Such systems reduce the need for hard copy files and enable the electronic tracking of tasks. These systems can be provided as a single package or as separate packages.

Many of these provide enhanced functionality. However, many of the functions provided by these packages can be rarely used as they are not required, particularly in the case of complex generic systems having superfluous or less aligned functionality.

Furthermore, often the packages comprise disparate systems that are not designed or intended to be integrated. Accordingly, it may be difficult to ‘retrofit’ these packages into existing electronic reminder systems, email clients, and word processing packages, leading to time/consulting/opportunity costs in integrating systems not expressly designed to be integrated.

Document management systems commonly are constructed in a way by which documents are retrieved on the basis of a complicated or complex classification structure whereby documents and data is retrieved from a database on the basis of this complex classification. Essentially, all of the data is assigned a complex classification and then stored in a single ‘box’ and is retrieved as required from this single ‘box’. This requires that the documents and data have the correct classifications in order to be retrieved.

Furthermore, often a single version of any one document can be stored which must then be checked in and out for editing. However, this process can be complex for both the system and for the user.

### DISCLOSURE OF THE INVENTION

The present invention seeks to overcome, or at least ameliorate, one or more of the deficiencies of the prior art mentioned above, or to provide the consumer with a useful or commercial choice.

Advantages of the present invention will become apparent from the following description, taken in connection with the accompanying drawings, wherein, by way of illustration and example, a preferred embodiment of the present invention is disclosed.

According to a first broad aspect of the present invention, there is provided an electronic case file and document management system stored on a server having one or more remote terminals coupled thereto, the case file and document management system comprising: a content and process application, a case management application, an email application and a mail integration application, wherein the content and process application is operable to provide an electronic case file function for storing and facilitating the display of data relating to one or more cases, and a task management function for creating and displaying data relating to tasks for the one or more cases, the remote terminals being arranged to access the electronic case file function, the task management function, the email application and the case management application for operation of the electronic case file and document management system.

Preferably, the data comprises electronic documentation.

Preferably, the case management application is coupled to a case management database, the case management database being arranged to store data relating to each case, and each case being identified by a unique identifier in the case management application.

Preferably, the electronic case file function is configured to store documentation in a folder structure comprising a plurality of folders, each folder having the unique identifier. Each folder may relate to a case and be associated with the related case by the unique identifier of the related case.

Preferably, the electronic case file function is operable to carry out a verification of the unique identifier prior to storing the documentation in the respective folder.

Preferably, the email application is coupled to an email integration application and is operable to transfer emails stored and displayed by the email application to the electronic case file function in a selected one or more of the folders.

Preferably, the task management function is operable to perform an action in respect of one or more tasks relating to one or more of the cases. Preferably, actions performed include creating, editing and/or displaying one or more tasks. The tasks may be stored in work queues with one or more users of the system being assigned as owners of the work queues.

Preferably, tasks are created by a user and are assigned to users of the system which may or may not be the person who created the task.

Preferably, the documentation stored in the content and process application can be viewed by users of the system by means of the remote terminals. The remote terminals may include an interface such as a web browser for viewing the documentation stored in the electronic case file function. The interface may further enable a user to perform an action in respect of one or more tasks. The actions performed may include creating, editing and/or viewing one or more tasks.

Preferably, tasks can be sorted and viewed by criteria. The criteria may be prescribed or predetermined and include one or more of: their creator, the person to whom the task is assigned, and/or by the unique identifier for the case to which the task relates.

According to a second broad aspect of the present invention, there is provided a method for storing documents and managing tasks associated with a case, the method comprising using an electronic case file function and a task management function provided by a content and process application stored on a server and accessible by a user with a remote terminal coupled to the server, the electronic case file function being arranged to store and facilitate the display of data relating to one or more cases, and the task management function being arranged to create and display data relating to tasks for the one or more cases.

Preferably, the data comprises electronic documentation.

Preferably, the case management application is coupled to a case management database, the case management database being arranged to store data relating to each case, and each case being identified by a unique identifier in the case management application.

Preferably, the method comprises the step of storing documentation in a folder structure via the electronic case file function, the folder structure comprising a plurality of folders, each folder having the unique identifier. Each folder may relate to a case and be associated with the related case by the unique identifier of the related case.

The method may comprise the further step of carrying out a verification of the unique identifier prior to storing the documentation in the respective folder.

Preferably, the method comprises transferring emails stored and displayed in an email application, and coupled to an email integration application, to the electronic case file function in a selected one or more of the folders.

Preferably, the method comprises the further step of performing an action in respect of one or more tasks relating to one or more of the cases using the task management function. Preferably, actions performed include creating, editing and/or displaying one or more tasks. The tasks may be stored in work queues with one or more users of the system being assigned as owners of the work queues.

Preferably, tasks are created by a user and are assigned to users of the system which may or may not be the person who created the task.

Preferably, the documentation stored in the content and process application can be viewed by users of the system by means of the remote terminals. The remote terminals may include an interface such as a web browser for viewing the documents stored in the electronic case file function. The interface may further enable a user to perform an action in respect of one or more tasks. The actions performed may include creating, editing and/or viewing one or more tasks.

Preferably, the tasks are sorted and viewed by criteria. The criteria may be prescribed or predetermined and include one or more of: their creator, the person to whom the task is assigned, and/or by the unique identifier for the case to which the task relates.

According to a third broad aspect of the present invention, there is provided a management system stored on a server having one or more remote terminals coupled thereto, the management system comprising: a content and process application, a case management application, an email application and a mail integration application, wherein the content and process application is operable to provide an electronic case file function for storing and facilitating the display of electronic documentation relating to one or more cases, and a task management function for creating and displaying data relating to tasks for the one or more cases, the remote terminals being arranged to access the electronic case file function, the task management function, the email application and the case management application for operation of the management system.

According to a fourth broad aspect of the present invention, there is provided a system, the system comprising a computer processor and a storage medium, the storage medium having a first software application and a second software application stored thereon, wherein the processor is operable:

under control of the first software application, to receive data relating to a record and to store the received data in a database associated with the first software application, the record including a unique identifier; and
under control of the second software application, to reference the record via the unique identifier.

Preferably, the processor is operable under control of the second software application to retrieve data relating to the record referenced via the unique identifier.

Preferably, the record relates to a case or a matter.

Preferably, the first software application comprises a case management application, and the second software application comprises a content and process application, and the processor is operable under control of the content and process application to provide an electronic record file function for storing and facilitating the display of data relating to one or more records via an interface, and a task management function for creating and displaying via the interface data relating to tasks for the one or more records.

Preferably, the electronic case file function is configured to store documentation in a folder structure comprising a plurality of folders, each folder having the unique identifier. Each folder may relate to a record and be associated with the related record by the unique identifier of the related record.

Preferably, the processor is operable under control of the electronic case file function to carry out a verification of the unique identifier prior to storing the documentation in the respective folder.

Preferably, the system comprises an email software application coupled to an email integration application and the processor under control of the email integration application is operable to transfer emails stored and displayed by the email application via the interface to the electronic case file function in a selected one or more of the folders.

Preferably, the processor is operable under control of the task management function to perform an action in respect of one or more tasks relating to one or more of the records. Preferably, actions performed include creating, editing and/or displaying one or more tasks via the interface. The tasks may be stored in work queues with one or more users of the system being assigned as owners of the work queues.

Preferably, the tasks can be sorted and viewed by criteria. The criteria may be prescribed or predetermined and include one or more of: their creator, the person to whom the task is assigned, and/or by the unique identifier for the case to which the task relates.

According to a fifth broad aspect of the present invention, there is provided a method for integrating a first software application and a second software application, the first software application associated with a database storing data relating to a record, the method comprising:

identifying the record by a unique identifier; and
using the unique identifier in the second software application to reference the record.

Preferably, the method further comprises retrieving data relating to the record referenced via the unique identifier.

Preferably, the record relates to a case or a matter.

According to a sixth broad aspect of the present invention, there is provided a method of allowing a first software application to access data stored in a database which is associated with a second software application, the database comprising a set of records, each record including a unique identifier, the method comprising:

allowing the first software application and the second software application to access a particular record by entering the unique identifier for that record into the application;
retrieving data associated with the record from the database; and
loading the retrieved data into the application.

Preferably, the record relates to a case or a matter.

According to a seventh broad aspect of the present invention, there is provided a computer-readable storage medium on which is stored instructions that, when executed by a computer, cause the computer to perform the method for storing documents and managing tasks associated with a case according to the second broad aspect of the present invention as hereinbefore described.

According to an eighth broad aspect of the present invention, there is provided a computer programmed to carry out the method for storing documents and managing tasks associated with a case according to the second broad aspect of the present invention as hereinbefore described.

According to an ninth broad aspect of the present invention, there is provided a computer-readable storage medium on which is stored instructions that, when executed by a computer, cause the computer to perform the method for integrating a first software application and a second software application according to the fifth broad aspect of the present invention as hereinbefore described.

According to a tenth broad aspect of the present invention, there is provided a computer programmed to carry out the method for integrating a first software application and a second software application according to the fifth broad aspect the present invention as hereinbefore described.

According to an eleventh broad aspect of the present invention, there is provided a computer-readable storage medium on which is stored instructions that, when executed by a computer, cause the computer to perform the method of allowing a first software application to access data stored in a database which is associated with a second software application according to the sixth broad aspect of the present invention as hereinbefore described.

According to a twelfth broad aspect of the present invention, there is provided a computer programmed to carry out the method of allowing a first software application to access data stored in a database which is associated with a second software application according to the sixth broad aspect the present invention as hereinbefore described.

Embodiments of the invention provide a programmed and automated means to integrate disparate systems through the use of a shared navigation method that ensures that structures in the content and process application, and the e-mail integration function are created and referenced consistently based on the unique identifier of a case as referenced via the case management application. This ensures that the structure of the content and process application is built correctly as new cases are added to the case management application. It also ensures that e-mails are stored correctly into the content and process application by the e-mail integration function.

The use of the unique identifier to reference information, such as case or task data, across disparate systems, such as the content and process application, the case management application, the email application, and the mail integration application, provides a means to avoid the overhead to copy, store and maintain duplicate data across systems. Further it avoids the risk that information in disparate sources could become non-consistent via an update in one system that was not simultaneously updated in the other system.

### DESCRIPTION OF THE DRAWINGS

In order that the present invention may be more fully understood and put into practice, a preferred embodiment thereof will now be described, by way of example only, with reference to the accompanying drawings, of which:

FIG. 1 is a block diagram illustrating the functional components of an embodiment of an electronic case file and task management system in accordance with an aspect of the present invention;

FIG. 2 is a screen shot of the view of the email application of the embodiment of the electronic case file and task management system of the present invention;

FIG. 3 is a screen shot of the view of the email application of FIG. 2 with a validation pop up window;

FIG. 4 is a screen shot of the view of the email application of FIG. 2 with a pop up window for entering attributes and values;

FIG. 5 is a screen shot of the view of the welcome window of the electronic case file function of the embodiment of the electronic case file and task management system of the present invention;

FIG. 6 is a screen shot of the view of the electronic case file view of the embodiment of the electronic case file and task management system of the present invention;

FIG. 7 is a screen shot of the view of the welcome window of the task management function of the embodiment of the electronic case file and task management system of the present invention;

FIGS. 8 and 9 are screen shots for selecting standard and ad-hoc task creation forms respectively in the task management function of the embodiment of the electronic case file and task management system of the present invention;

FIGS. 12 to 16 are screen shots of different view of tasks created in the task management function of the embodiment of the electronic case file and task management system of the present invention;

FIG. 17 is a screen shot of a view in the case management application illustrating the links to the task management and electronic case file functions of the system of FIG. 1; and

FIGS. 18 to 20 are screen shots of aspects of the delegation function of the embodiment of the electronic case file and task management system of the present invention.

### BEST MODE(S) FOR CARRYING OUT THE INVENTION

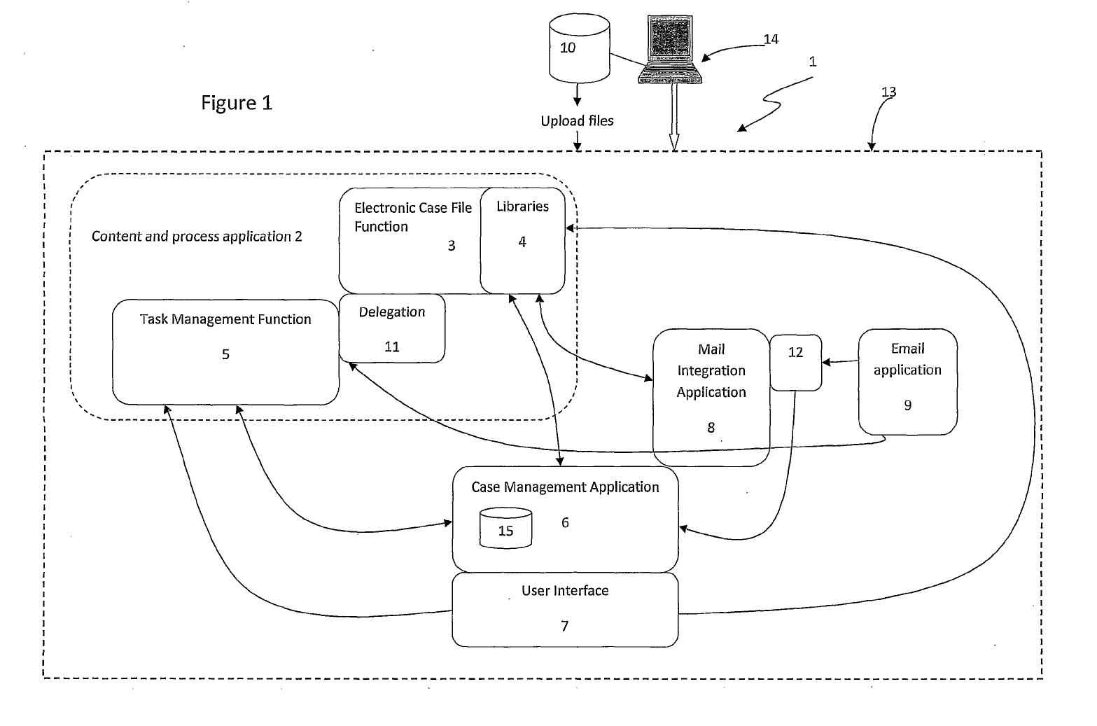

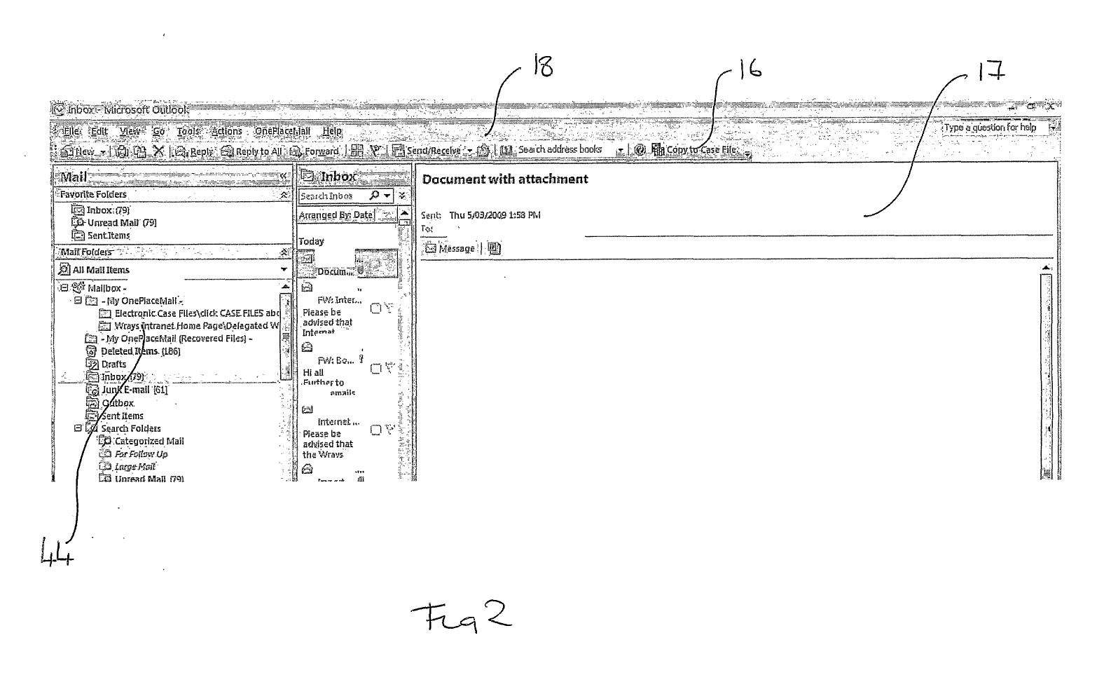

An embodiment of a system 1 in accordance with an aspect of the present invention comprises a number of software applications that are illustrated schematically in FIG. 1.

In the embodiment described, the system is for managing electronic case files and tasks relating to work and activities of a patent and trade mark attorney firm. In alternative embodiments, the present invention could be applied and varied to suit other uses such as for use by law firms, accounting firms and other professional services firms to manage activities with appropriate modification to suit the user requirements.

The system 1 comprises a number of software applications that provide the functionality to enable the system 1 to be operable as described below. The software applications are stored and run on a server 13 comprising a computer processor and a suitable storage medium or memory (not shown). In alternative embodiments, the applications can be stored and run on a number of interconnected servers, or any suitable computer.

Software in the software set, or any instructions or programs for the system 1, can be written in any suitable language, as are well known to persons skilled in the art. Furthermore, the software can be provided as standalone applications or via a network, depending on the system requirements.

The server 13 is part of a local area network comprising one or more remote terminals 14. In the present embodiment, the terminals 14 are laptop or desktop computers coupled to the server 13 in any suitable, known manner for data communication therewith. In an alternative embodiment, the terminals 14 can be coupled via a wide area network, such as the Internet. The coupling can be wired or wireless using any suitable protocol. A suitable interface, such as a graphical user interface, is presented to users (not shown) via the terminals 14, to enable the user to access and use the system 1. In the present embodiment, the graphical interface is a web browser—as is well known to persons skilled in the art.

Although, in this embodiment, a single server 13 is described, a number of linked servers could also be used.

The terminals 14 are also in data communication with one or more disk drives 10 which store files to be used by software applications. This may include, for example, documents created by word processing software applications such as Microsoft Word®.

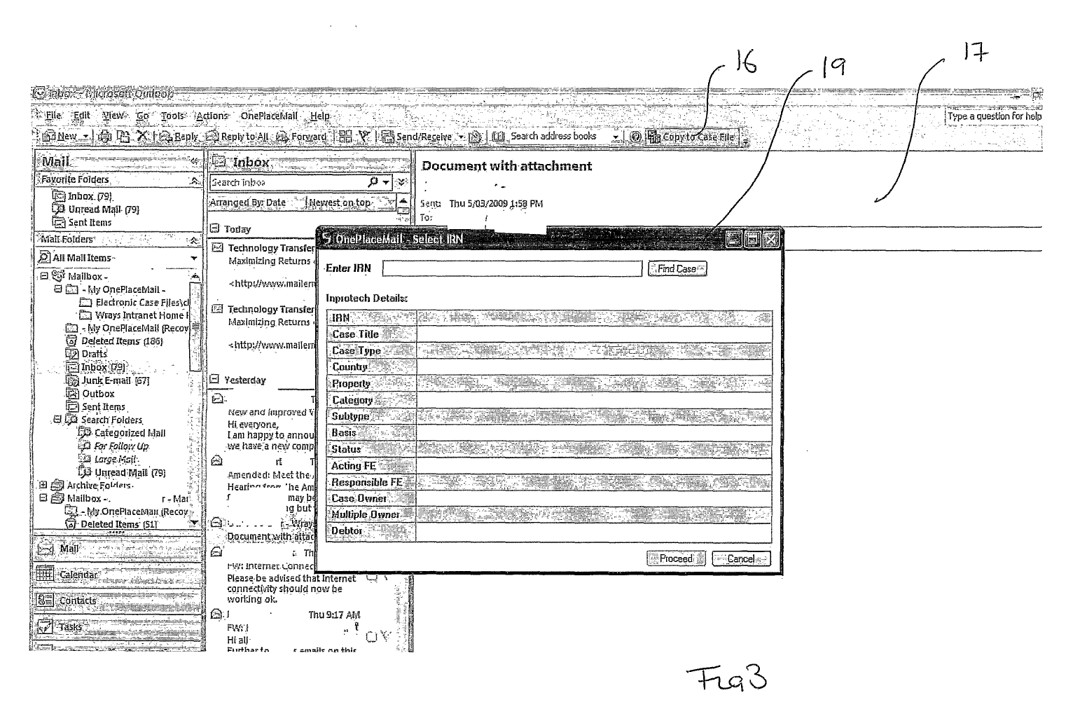

The software applications include:
A first application in the form of a content and process application 2 that enables the management of electronic or digital content and processes. In the embodiment that is described herein the content and process application is Sharepoint™, a browser-based collaboration and document management application from the Microsoft Corporation. The use and operation of Sharepoint™ is well known to persons skilled in the art and need not be described in any further detail herein except as is relevant to the present invention. As is also well known, Sharepoint™ functionality is presented to the user via the web browser using the respective terminal 14. In Sharepoint™, the functionality is enabled through the use of site collections. A site collection includes one or more sites. The use of sites and site collections in Sharepoint™ is well known to persons skilled in the art and need not be described in any further detail herein. In this specification, the term “SharePoint” may be used when referring to the content and process application 2 as this is the specific embodiment described herein.
A second application in the form of a case management application 6 that enables users to manage data and information to facilitate the running of an enterprise such as a professional services firm, for example providing legal or patent and trade mark attorney services in the embodiment described. This will provide a database 15 of records relating to cases or matters being handled by the firm. Data is stored in a database 15 with each case having a unique identifier which may be referred to further herein as an IRN (“internal reference number”). In the present embodiment, the database 15 is a relational database server such as one using SQL 2000, although any other suitable database could be used. The case management application 6 enables case data to be stored and generated against each case. Such case data may include deadlines, official numbers, and client names and addresses. The case management application 6 is also operable to generate reminder services, handle billing and accounting services related to the cases, record time and disbursements against individual cases and so on. The case management system 6 includes a user interface 7 that provides a ‘user friendly’ browser-based means of enabling the user to access the case management system 6 and to retrieve and input data. In the embodiment described herein, the case management application 6 is Inprotech™ created by Computer Patent Annuities Ltd with the user interface 7 being the Inprotech™ Workbench™. This case management application is well known to persons skilled in the art and need not be described in any further detail herein, except as is relevant to the present invention. In this specification, the term “Inprotech” may be used when referring to the case management application 6 as this is the specific embodiment described herein.
A third application in the form of an email application 9 such as Outlook™ from Microsoft Corporation. The email application 9 displays emails in one of more windows 17. This is illustrated schematically in FIG. 2, which shows a typical Outlook™ view with incoming emails in an Inbox, a left pane showing a navigable folder structure for stored emails and which includes incoming and sent emails, a viewing pane for viewing selected emails and toolbar 18. As is well known, the email application 9 enables users to draft and send as well as receive emails.
A fourth application in the form of a mail integration application 8 such as the proprietary application called OnePlaceMail™ from Scinaptic Communications Pty Ltd. The mail integration application 8 enables the integration of mail from a user's Inbox in the email application 9 to the content and process application 2.

The content and process application 2 is configured to display to the user a series of web or electronic pages, each web page displaying data and information to the user and including functionality to enable the user to navigate through the system 1 and to input data as required.

As mentioned above, this is done—in the embodiment described herein—through the creation of sites and site collections. Typically, the user is able to navigate through the series of web pages, and to select, display and input data as required using a keyboard and a mouse and data entry fields in the usual way. For example, selecting a document displayed in a web page can be done by using the keyboard and/or mouse to move a cursor around the page and using so-called ‘mouse-clicks’.

The content and process application 2 includes two system functionalities: a task management function 5 (which may be referred to hereinafter as TMS) and an electronic case file function 3 (which may be referred to hereinafter as ECF). Both of these functionalities are provided as Sharepoint™ site collections.

The task management function 5 provides a user with the ability to perform actions to manage day-to-day functions as will be described in further detail below.

The electronic case file function 3 presents to the user, through the browser window, a list of electronic case files and data relating thereto, as described below. Each electronic case file is an electronic equivalent of a conventional paper file which contains documents and information that relates to a specific matter, such as letters, emails, specifications, drawings, spreadsheets and so on.

Each electronic case file relates to a single matter or case with which the user can deal. As an example, this case could be a patent or trade mark application in the embodiment described.

The data and documentation relating to each electronic case file is stored in a folder associated with the relevant site collection. Each folder has a unique identifier (IRN) associated with or related to it which can take the form of a six digit number in the embodiment described. In alternative embodiments of the invention, alternative unique identifies may be used.

The unique identifiers correspond to the unique identifiers for the records used in the case management application 6. The electronic case file function 3 therefore provides a document management facility for cases, details of which are created and stored in the case management application 6 in the case management database 15.

The folders are stored in a hierarchical manner within a set of libraries 4. Each library is based on a range of unique identifiers using the first three digits of the unique identifier. For example, the case file folder for case file number 123456 will be located in library 123.

Additional libraries are also provided to store metadata for email and the electronic case file folders.

The folder/directory structure is constructed as follows:

Server/site collection/library/folder name.

The electronic case file function 3 works, with the content and process application 2, to present to the user, via the browser, case file data, including electronic documents/documentation and other files and information, relating to any electronic case file, to enable the user to deal with, and manage the case electronically, and to view documents, emails and information relating to the case, and other case management functions. This will be described in further detail below.

The electronic case file function 3 is in data communication with the case management application 6 to enable the database 15 to be queried or referenced to obtain relevant data relating to the electronic case file. The case management application 6 stores data relating to each of the cases, each of which has a unique identifier as mentioned above. As previously described, this unique identifier has a corresponding electronic case file with the same unique identifier.

The reference to the case management application 6 by the electronic case file function 3 occurs only at the time of the reference and therefore the case management information does not have to be separately stored and additionally maintained specifically for the electronic case file function 3. This is advantageous as it avoids the overhead of additional electronic storage space required for such separate storage, the associated maintenance activities and the risk that instances of data could be referenced by the electronic case file function 3 that had been made invalid by updates to the case management application 6 that had not been applied to a separate and redundant data store used by the electronic case file function 3.

Where a folder name is deemed valid via the existence of an IRN in the case management application 6 but the folder does not exist in the electronic case file function 3 then the electronic case file function 3 is operable to create the folder using a predetermined method to ensure that the folder is created in the correct location and with the correct name that will allow the folder to be subsequently referenced and navigated to. The electronic case file function 3 is operable to build the appropriate Universal Record Locator (“URL”) which is used to specify locations in the electronic case file function 3. The build of the URL is predictable as this can be dynamically and accurately determined via a combination of a static component plus a dynamic component based on the name of the IRN. This URL is used as part of the initial creation of the folder in the electronic case file function 3. This is a key advantage of the embodiment of the invention as it minimises and may avoid the high risk of error if this folder navigation were to be attempted manually.

Emails are integrated from the email application 9 using the email integration application 8. A navigation function 12 enables a user to input the relevant unique identifier for one (or more) electronic case files to enable a copy of the email to be sent to the relevant electronic case file as will be described in further detail below. The navigation function 12 is coupled to the case management application 6.

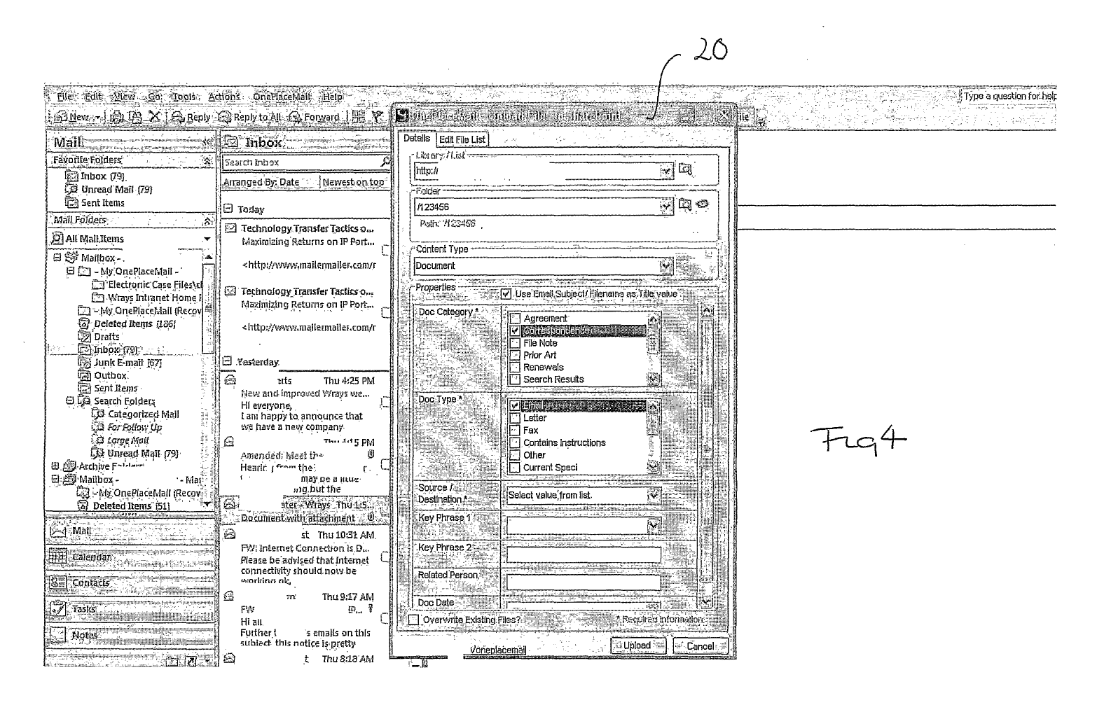

When an email is received by a user in the email application 9, the user is able to copy the email to the electronic case file by selecting and clicking a button 16 displayed in the toolbar 18 window 17. When this is selected, the navigation function 12 is operable to display a pop up window 19—see FIG. 3, which prompts the user to input a unique identifier corresponding to the relevant case to which the email relates.

The navigation function 12 is then operable to query or reference the case management application database 15 and to check whether the input unique identifier matches one in the case management application database 15. If it does, then the details of the case (as extracted from the case management application database 15) are displayed to the user in the pop up window 19. This enables the user to check that they have selected the correct case for that email. If it is correct, then the email can be copied to the relevant electronic case file in the electronic case file function 3 in response to the user clicking on the Proceed button provided in the pop up window 19.

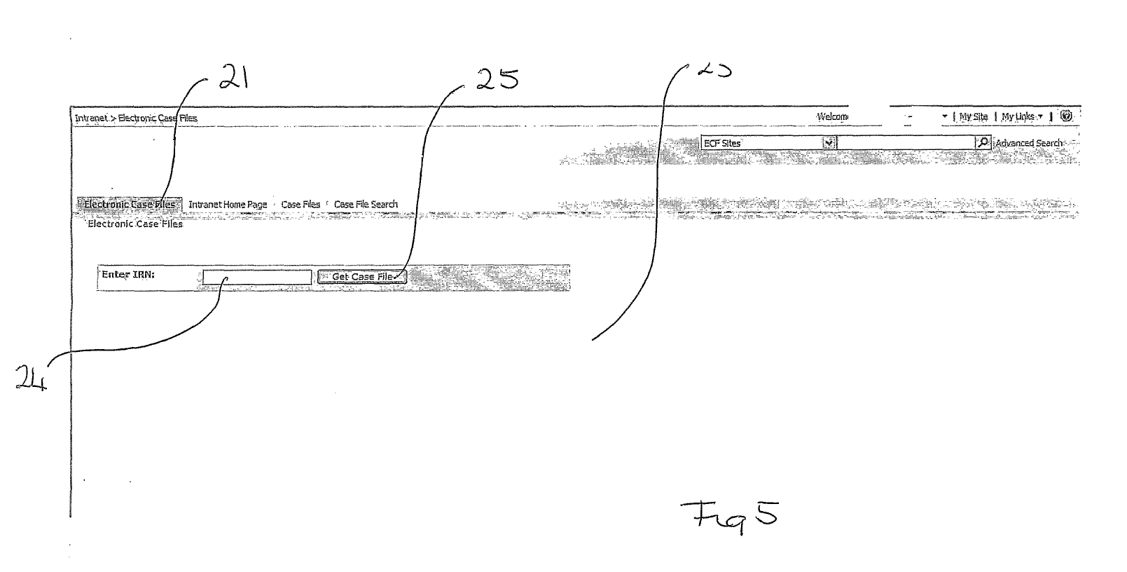

Before the email is copied to the electronic case file, the user is presented with another pop up window (see FIG. 4) which enables the user to apply categories/attributes to the email before it is stored in the electronic case file. These attributes can be used to enable documents to be searched and retrieved once stored.

If the details are incorrect, then the user can cancel the action, and input another unique identifier as required. If there is no match, then an error message is displayed to the user and the user is then able to retry with a new unique identifier and so on. This ensures that emails are copied to the correct electronic case file folder in the libraries 4.

In such situations in particular, and in general, it can be seen that the case management application 6 functions as a gatekeeper to ensure that the case reference—input unique identifier—is valid before allowing the action to proceed. This is advantageous as it helps to prevent users from entering incorrect or invalid information into the system.

The reference to the case management application 6 by the navigation function 12 occurs only at the time of the reference and therefore the case management information does not have to be separately stored and additionally maintained specifically for the navigation function 12. This is advantageous as it avoids the overhead of additional electronic storage space required for such separate storage, the associated maintenance activities and the risk that instances of data could be referenced by the navigation function 12 that had been made invalid by updates to the case management application 6 that had not been applied to a separate and redundant data store used by the navigation function 12.

In the embodiment described, the navigation function 12 has been programmed and is operable to store the e-mails into the correct location in the electronic case file function 3. The navigation function 12 is operable to build the appropriate URL which is used to specify locations in the electronic case file function 3. The build of the URL is predictable as this can be dynamically and accurately determined via a combination of a static component plus a dynamic component based on the name of the IRN using the same means to calculate the URL as used when the case file folder in the electronic case file function 3 was first created. This is a key advantage of the embodiment of the invention as it minimises and may avoid the high risk of error if this navigation were to be attempted manually.

It can be seen that case management information is associated with one source or store—the case management application 6—which is referenced by the electronic case file function 3 and the navigation function 12 using the unique reference IRN as a “key” to access the data in the source or store.

This method ensures that structures in the content and process application 2, and the e-mail integration application 8 are created and referenced consistently based on the unique identifier of a case as referenced via the case management application 6. This ensures that the structure of the content and process application 2 is built correctly as new cases are added to the case management application 6. It also ensures that e-mails are stored correctly into the content and process application 6 by the e-mail integration application 8.

The use of the unique identifier to reference information, such as case or task data, across disparate systems, such as the content and process application 2, the case management application 6, the email application 9, and the mail integration application 8, provides a means to avoid the overhead to copy, store and maintain duplicate data across systems, and to integrate the systems. Further it avoids the risk that information in disparate sources could become non-consistent via an update in one system that was not simultaneously updated in the other system.

Other documents can be stored in the relevant folders by uploading documents from other locations—such as a network drive 10. In this embodiment, this is done using the standard ‘Upload’ function provided with Sharepoint™.

In use, a user will open their browser on their laptop or computer 14 in the usual way and will browse to access the electronic case file function 3 through the web browser in any usual way. In the preferred embodiment, the electronic case file function 3 and task management function 5 are presented as tabbed web pages 21, 22 within an Intranet portal environment. The user can select either the electronic case file function 3 or the task management function 5 by selecting, for example, the relevant electronic case file function tab 21, or task management function tab 22, or via displayed links in the Intranet portal home page or any other suitable way.

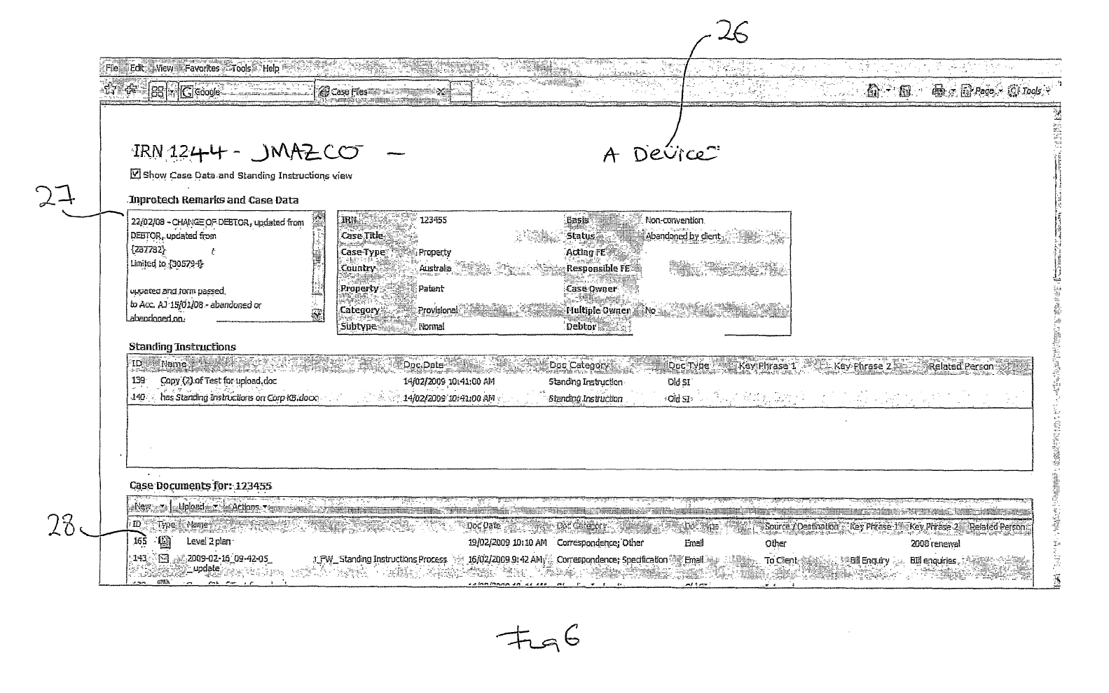

Upon selection of the electronic case file function tab 21, a select electronic case file web page 23 is displayed to the user in the web browser—see FIG. 5.

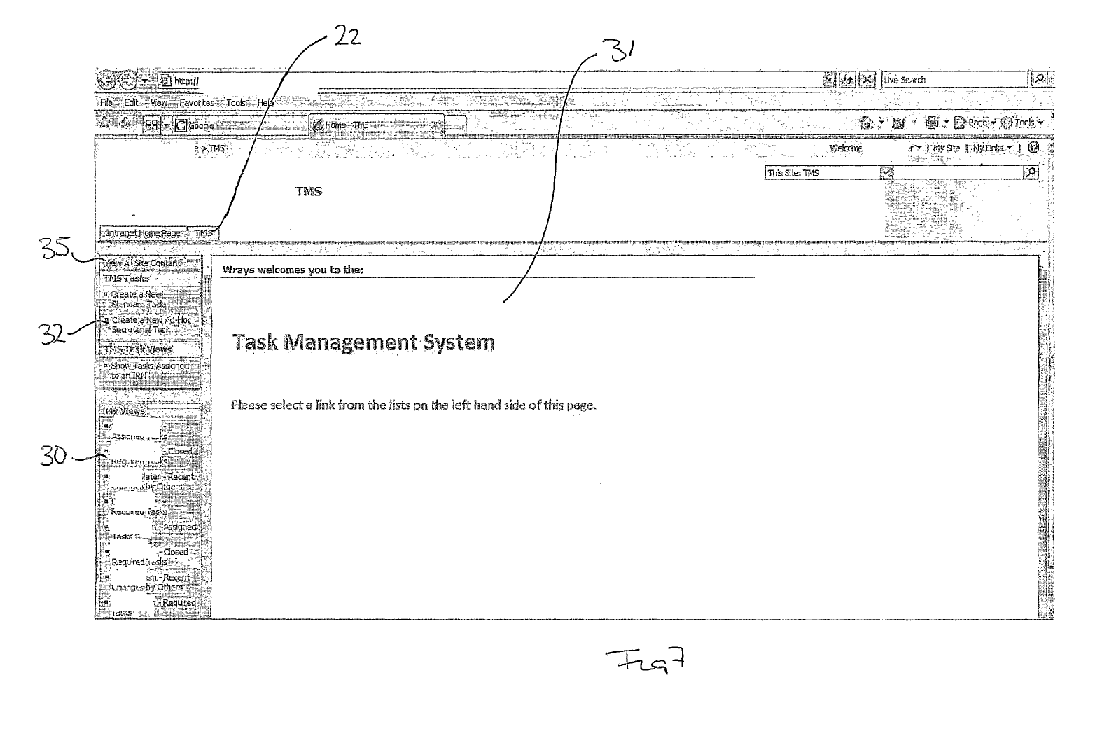

The user is prompted to enter the required unique identifier into the “Enter IRN” field 24 and to click “Get Case File” button 25. In response to this, the content and process application 2 is operable to query the case management application 6 and to verify that the unique identifier is a valid identifier and—if so—to extract the relevant case data. The user is then presented, as illustrated in FIG. 6, with a web page 26 which contains data relating to the selected case, and includes: case management data 27, and any stored case documents 28. The case management data 27 is sourced from the case management application 6 by querying the case management database 15 and displaying the data in the electronic web page 26. The stored case documents are those stored within the electronic case file function 3 as described above.

The electronic case file function 3 includes a search facility which enables the electronic case files to be searched using metadata such as the attributes entered when the document is uploaded to the electronic case file folder. Such metadata may include, for example: Document Name; Category; Document Type and Key Phrases. The use of metadata for searching in content and process applications such as SharePoint™ is known.

In this way, therefore, a user is able to store and access documentation relating to a case that has been assigned a unique identifier. The user is also able to view data relating to the case as stored within the case management application database 15.

The task management function 5 provides for tasks relating to individual cases to be created. Those cases are the same as those referred to above in relation to the electronic case management function 3 and have the same identifiers. The task management function 5 is also coupled to the user interface 7 and case management application and is so able to query the case management application database 15 in the same way as the electronic case file function 3 and extract data, for example, for display to the user.

The task management function 5 enables users to create details of work tasks or other activities to be performed. These tasks may include information on the case to which the task is related (using the unique identifier), text setting out the task to be performed, a due date for completion of the task and the ability to attach relevant documents to the task. The task is also allocated to a user of the system 1: this can be the person who created the task or another user. Tasks then form part of a work queue.

Details of users of the task management function 5 (and therefore of the system 1) are stored in the task management function 5 in a “Users Group”. Certain users can also be in other groups such as an “Administrators Group” or “Queue Managers Groups”. The users in these other groups have additional permissions (depending upon the group) that allow them to administer the system 1 or have additional management functions as required and described further below.

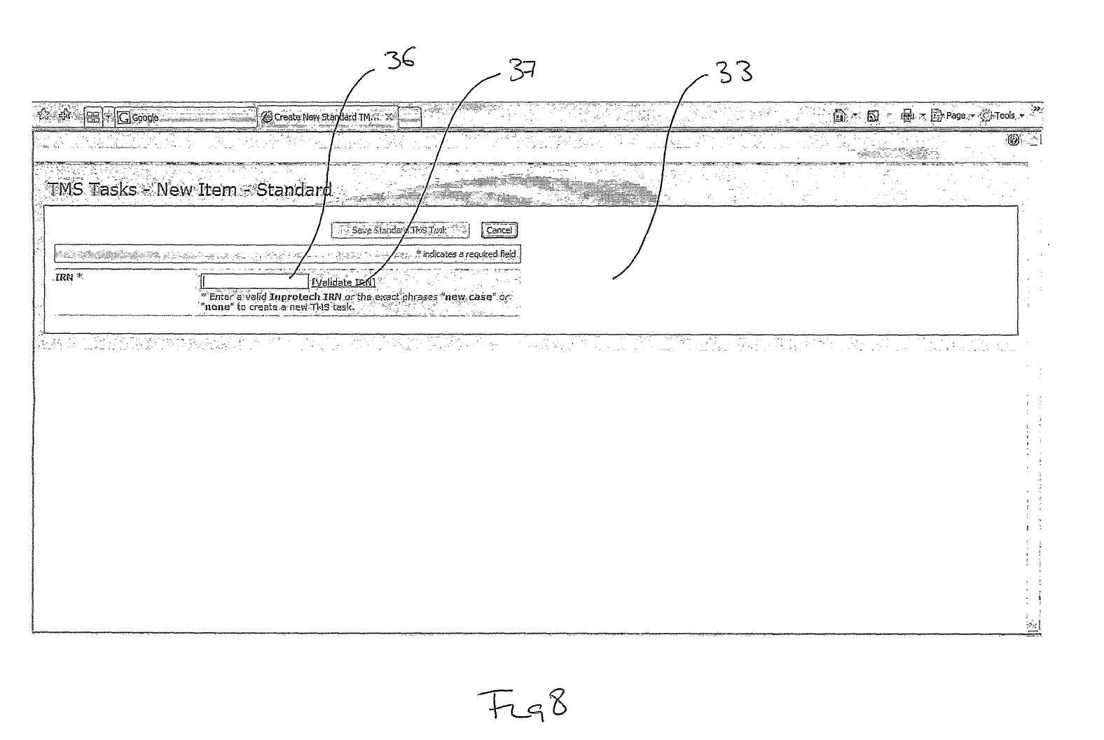

As with the electronic case file function 3, the task management function 5 is displayed to the user via the web browser: typically as a series of web pages, selectable through links or the task management function tab 22 (as described in respect of the electronic case file function 3 above). This is illustrated schematically in FIG. 7.

As can be seen in FIG. 7, when accessing the task management function 5 the user is presented with an initial Welcome webpage 31. The user is able to select a number of different views 30 which display tasks stored within the task management function 5 depending upon predetermined criteria. In the preferred embodiment, these views may (listed on a side toolbar 35 of the Welcome webpage 31) include: the user's required tasks (i.e. tasks which have been created by that user but assigned to others); tasks assigned to the user; tasks recently assigned to the user that have been changed by another user; and tasks that have been completed. Other views may be provided.

The views are displayed as hyperlinks that the user can select in the usual, known way from the side toolbar 35.

The user is therefore able to select and view tasks that have been assigned to the user and is also able to create new tasks (that can be assigned to the user creating the task or to another user of the system 1).

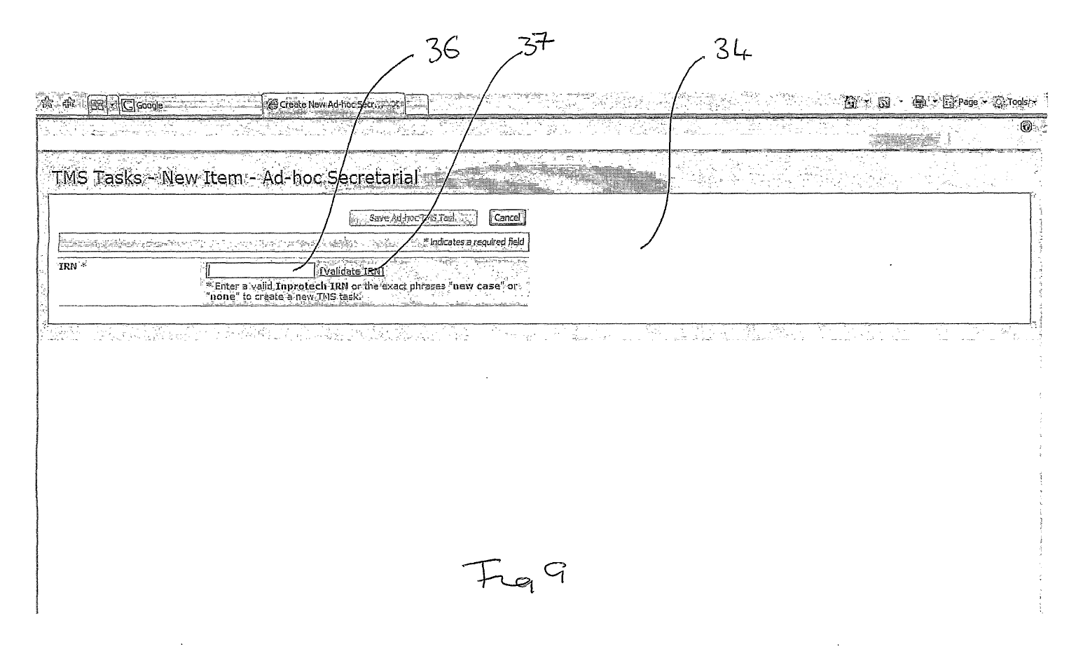

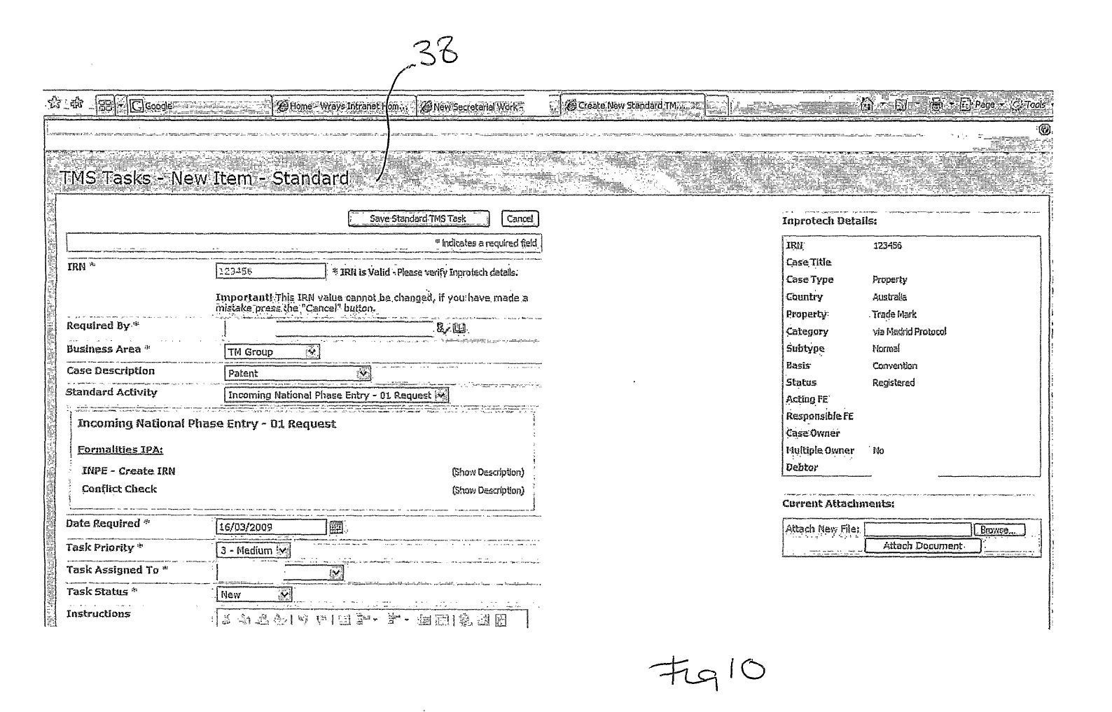

To create a new task, the user selects a Create New Task link 32 on the Welcome webpage 31—which can either be for a new standard task or an ad-hoc task. The user is then presented with a Create New Standard Task webpage 33 (FIG. 8) or Create New Ad-hoc Task webpage 34 (FIG. 9). The user inputs either the unique identifier of the case to which the task relates (or predefined text such as ‘new case’ if the task does not relate to a specific case) into an IRN field 36. The unique identifier needs to be checked to ensure that this unique identifier relates to a valid unique identifier. To do this, the user selects a ‘validate’ link 37 and, in response, the task management function 5 is operable to query the case management database 15 to check that the unique identifier is valid (in the same way as is done in the electronic case file function 3). The task management function 5 is operable to check if a unique identifier querystring has been passed to the page, and if found a lookup and validation is performed:
Valid identifier—populate the form accordingly
Invalid identifier—display that the IRN was invalid, disable form
Querystring=“new case”—enable form, all fields blank

Once the unique identifier has been validated, the task management function 5 is operable to extract the relevant case management data from the case management database 15 and to display the data in a relevant task creation form 38 (FIG. 10), and 39 (FIG. 11) which is displayed to the user. There are two task creation forms—one for creating standard tasks 38 and one 39 for creating ad-hoc tasks. Standard tasks are those that are standard for the workplace whereas ad-hoc tasks are those tasks that occur on an ad-hoc basis and as required.

The task creation form 38, 39 enables the user to input the required information such as the person to whom the task is to be assigned, the due date for the task, information about the task, an indication of the difficulty of the task, task status and so on—as can be seen in FIGS. 10 and 11. This is done by providing a number of fields that enables the user to input data and assign values as required. The user is also able to attach any relevant documentation by browsing for documents stored, for example, on attached drives 10 in the usual way.

Once the required task creation form 38, 39 is completed, the user can save the task and it is stored by the task management function 5. The new task will be displayed to the user to whom the task has been assigned—for example through the respective views of that user as described above.

Each task creation form 38, 39 includes a number of fields that need to be populated by the user—the fields vary depending upon whether it is for a standard task or for an ad-hoc task. The new task is then saved once all of the fields are filled appropriately.

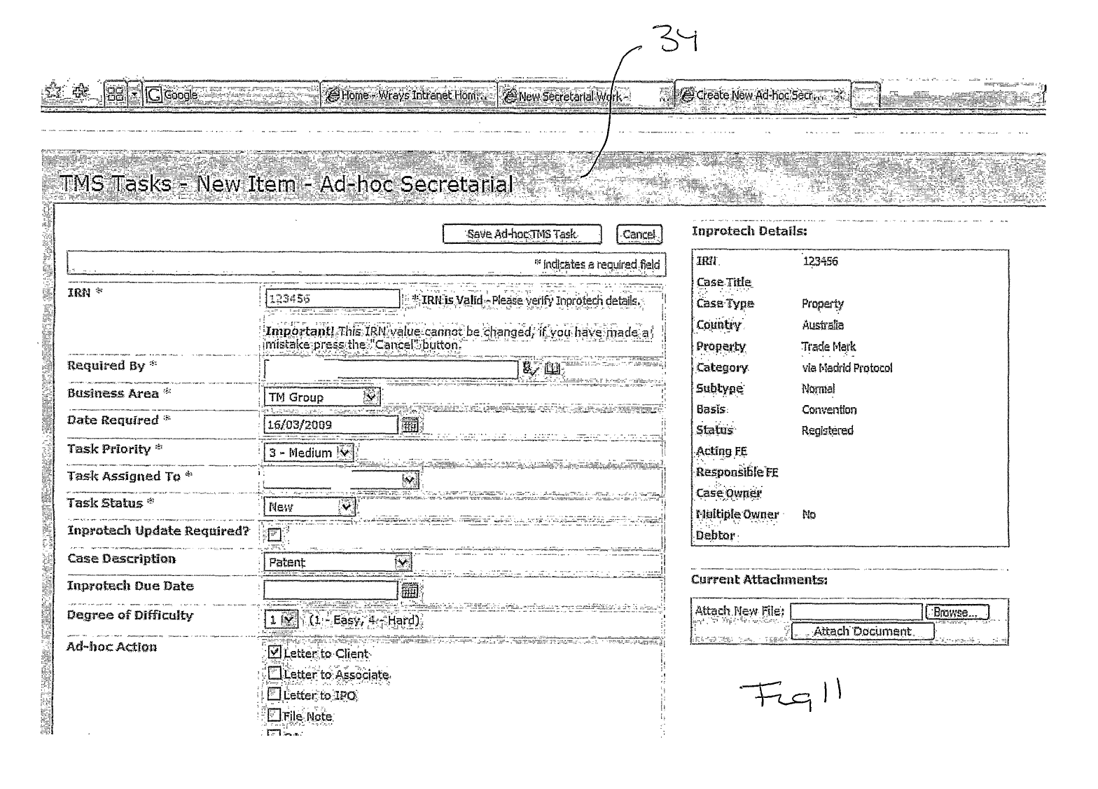

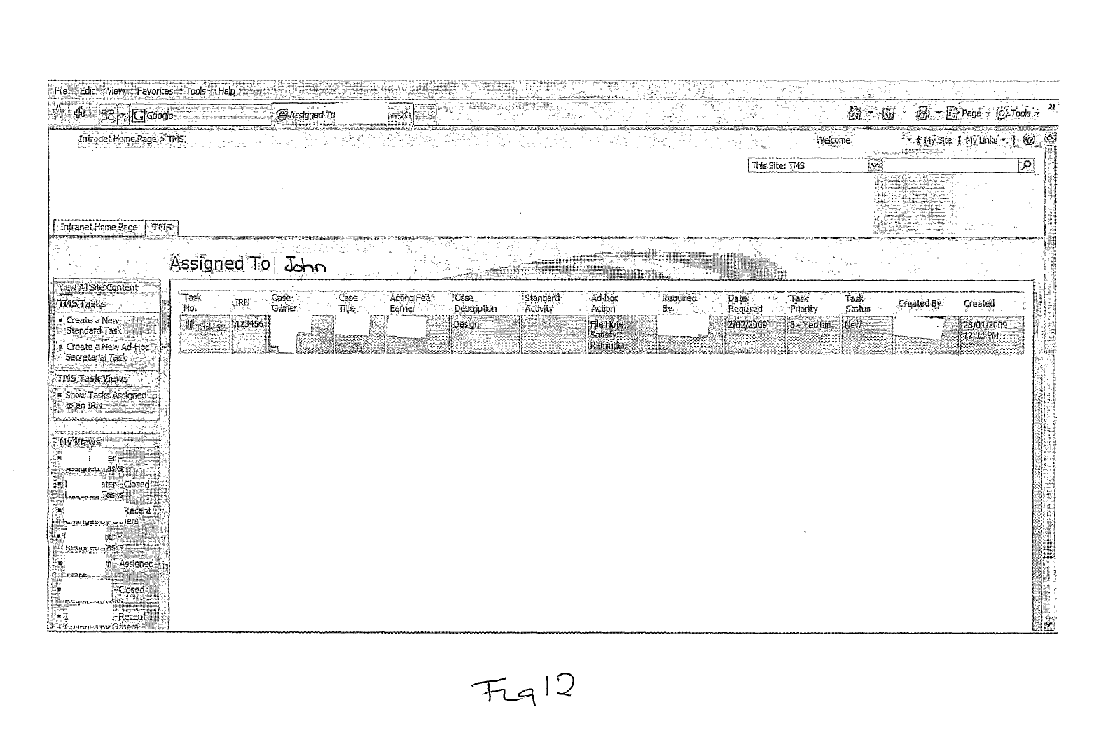

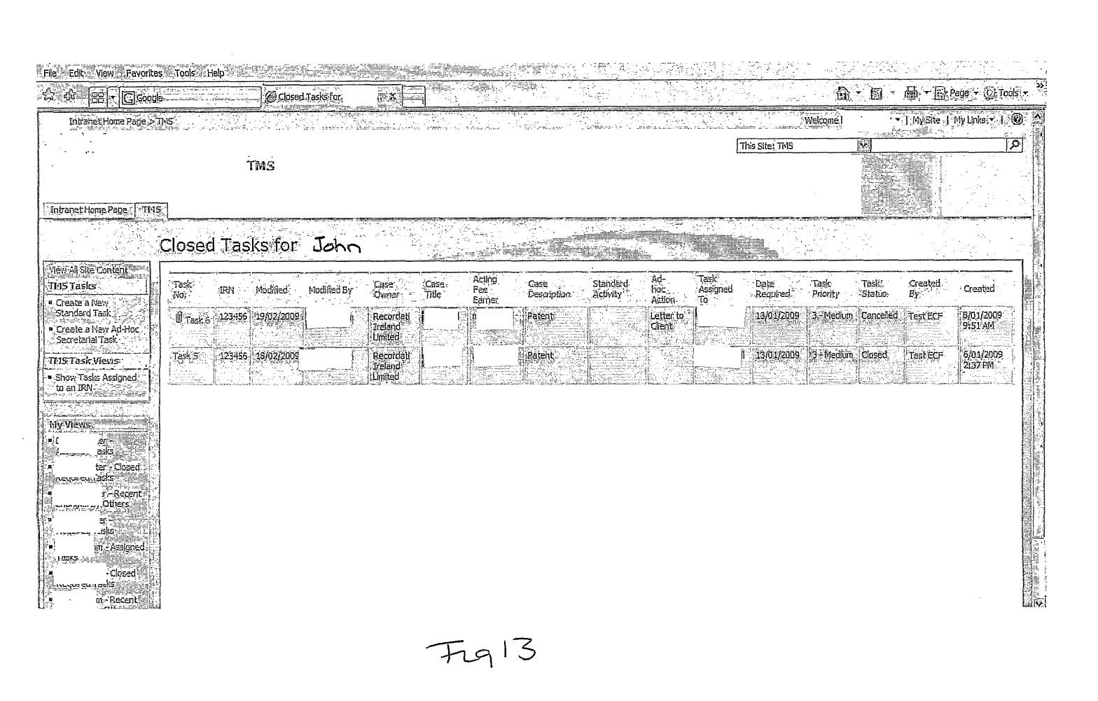

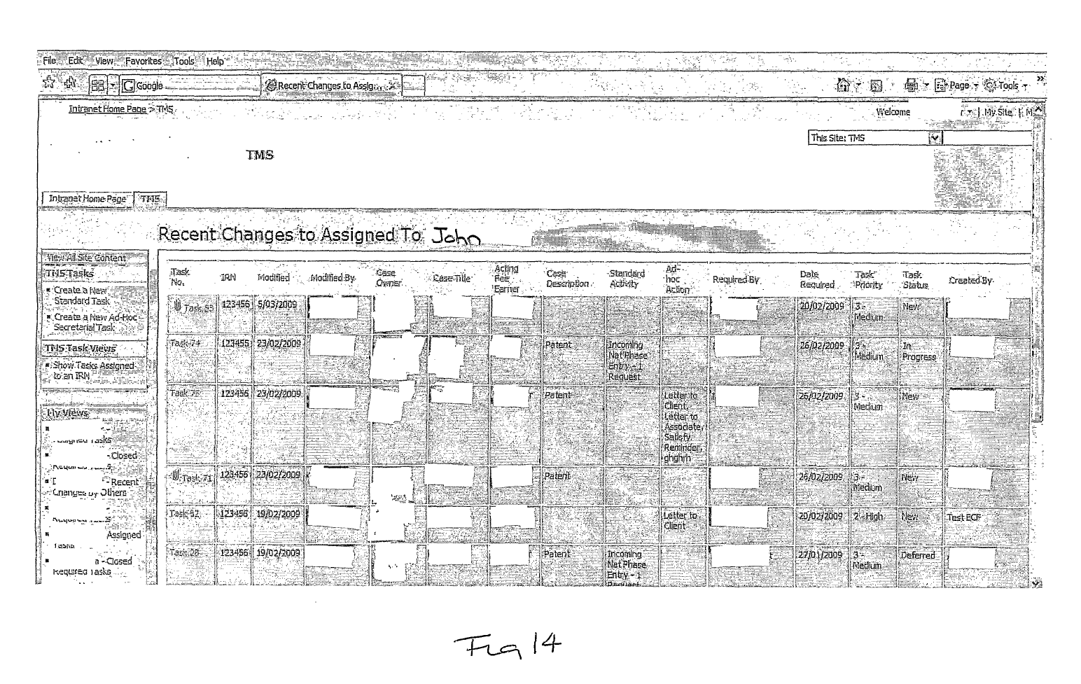

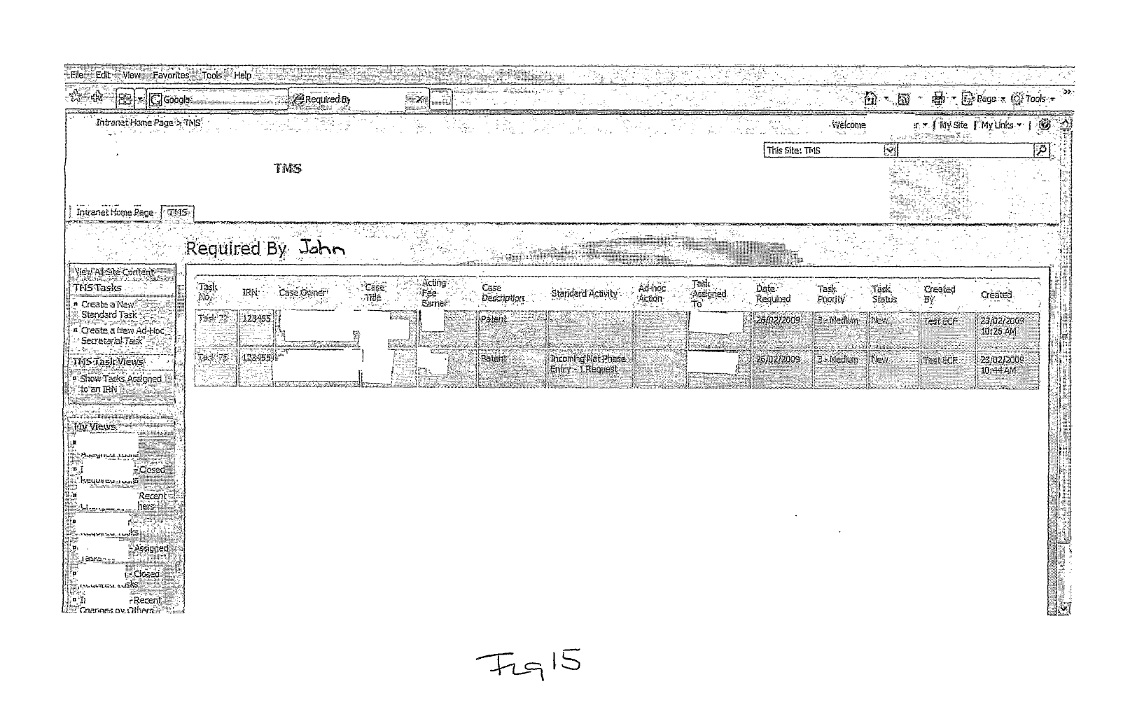

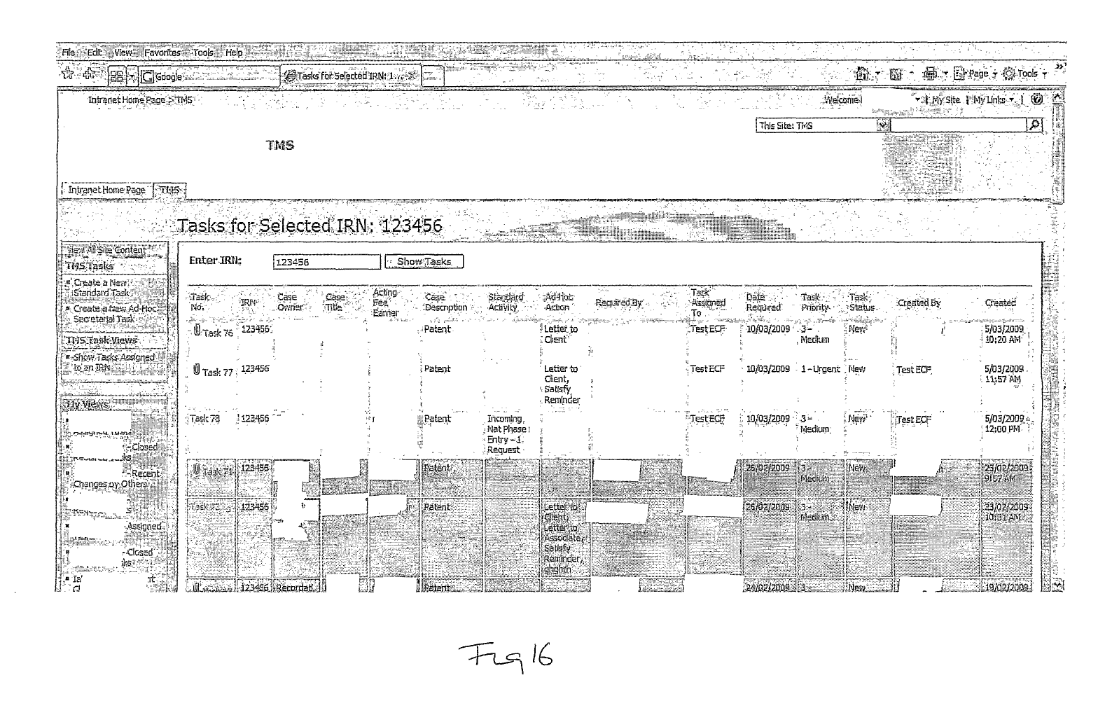

A user can view any assigned or required task by selecting the appropriate view and selecting the required task. If it is an assigned task, the user is able to change the task status to “completed” when the work has been done. The user who assigned the task to the user is also able to view the same task—via the appropriate view—and to see that the task status has changed to “completed”. FIGS. 12 to 16 illustrate different views that are available.

Tasks are assigned to a work queue. A work queue is owned by a user of the system 1. A work queue may have more than one owner. Generally, tasks are assigned to a work queue depending upon to whom that task is assigned with the owner of that work queue being the ‘assigned to’ user. Only the owner can edit tasks. However, two or more users can have ownership of a work queue which means that all of the users can edit the tasks. This provides additional flexibility. In practice, for example, if the assigned to person is a senior worker, then a personal assistant can also be an owner of the work queue, therefore enabling them to edit the tasks and deal with them on behalf of the senior worker.

If a task is to be edited (with the appropriate permissions) then the user selects the relevant task by the task number 40—each task being assigned a unique number or other identifier within that work queue.

This then opens up a new window 41 which can then be edited as required.

As mentioned above, the task management function 5 is created in the content management application 2. In the embodiment described herein, the task management function 5 is implemented using SharePoint™ and SharePoint™ lists. Lists are a collection of information that can be shared by users. Lists include one or more columns to enable the information to be easily displayed and navigated—in this way the functionality described above can be implemented.

Further details on the implementation will be described below. In the embodiment described herein, the task management function will include six lists and three content types.

The lists are referred to in the following format: ListName: FieldName e.g. “Work Queue Management: Queue Name” when defining relationships between list fields.

The different lists in the embodiment will now be described.

### “Work Queue Management” List

### List Definition:

| Field | Data Type | Description | Behaviour |
|---|---|---|---|
| Queue | Text | “Queue Name” is the column that any | On data entry and edit; |
| Name | | TMS task's “Task Assigned To” field | perform validation against |
| | | should be validated against | members of the Users |
| | | This column can have a number of | Group to ensure the |
| | | entries for the same value ie non- | specified username exists; |
| | | unique | and the values specified in |
| | | The values for this column will be: | the “Special Queues” list |
| | | All current staff members - in | on data entry/edit |
| | | the AD format of firstname + | Override the New & Edit |
| | | first letter of surname eg | forms to implement |
| | | michaelv | custom behaviour |
| | | Special queues as stored in | |
| | | the “Special Queues” list | |
| Queue | Person | This Person field looks up all | No multiple values allowed |
| Owner | (SharePoint | members in the Users Group | in this field value |
| | Group) | This column is the AD name of the | People Only |
| | | user who we are allowing to update | If a member has been |
| | | tasks assigned to the “Queue Name” | removed from this list, the |
| | | value | Edit form will show a blank |
| | | The data will be in the AD | value on the next edit. |
| | | format of firstname + first | Display a user friendly |
| | | letter of surname eg michaelv | message for re-assigning |
| | | This column can have a number of | an owner |
| | | entries for the same value ie non- | |
| | | unique | |
| | | In the custom Edit Task form, must | |
| | | match the logged on user to a row or | |
| | | rows in this column, then match the | |
| | | related “Queue Name” against the | |
| | | “Assigned To” person on the task | |
| | | before allowing update. | |
| Business | Lookup | Lookup on the “Business Area” Site | |
| Area | | Column. | |

### List Example:

| Queue Name | Queue Owner | Business Area |
|---|---|---|
| Michaelv | Michaelv | IT |
| IT | Michaelv | IT |

### Default Assigned to Person” List

### List Definition:

| Field | Data Type | Description | Behaviour |
|---|---|---|---|
| Staff Member | Person | The user in AD format | If a member has been |
| | | Person field lookup members of the | removed from this list, the |
| | | Users Group | Edit form will show a |
| | | | blank value on the next |
| | | | edit. Display a user |
| | | | friendly message for re- |
| | | | assigning an owner |
| Default | Lookup | Lookup to the “Work Queue | If the entry has been |
| Assigned to | | Management: Queue Name” field | removed or is not found |
| Queue | | | or if the “Queue Name” is |
| | | | invalid do nothing - just |
| | | | return what is there, or if |
| | | | not found, a blank |
| | | | No error message |
| | | | required |

Only members of the Administrators and Queue Managers Groups can manage the items in this list. Users Group members have “Read only” permissions.

The “Default Assigned To Person” list depends on the “Work Queue Management” list as the “Default Assigned To Person: Default Assigned to Queue” field requires a reference to the Lookup field “Work Queue Management: Queue Name” for valid values.

### “Special Queues” List

### List Definition:

| Field | Data Type | Description | Behaviour |
|---|---|---|---|
| Queue | Text | Default values | Purely for validation purposes; |
| Name | | include work | lookup from the “Work Queue |
| | | place | Management” list |
| | | departments; | |
| | | Data Enterers | |
| | | Renewals | |
| | | Accounts | |
| | | Professional | |
| | | groups | |

This table is used solely as a lookup table for validating a special queue name. Only members of the Administrators Group can manage the items in this list. Members of the Users Group have “Read only” permissions.

### “Standard Activities” List

### List Definition:

| Field | Data Type | Description | Behaviour |
|---|---|---|---|
| Title | Text | Will be pre-populated | Purely for information |
| | | with Standard | purposes |
| | | Activities | |
| Case | Lookup | Lookup to the Case | “Standard Activities” are |
| Type | | Type site column | categorised by Case Types |
| Is | Choice | Determines if the | Default to “Yes” |
| Valid | | Standard Activity is | |
| | | currently a valid | |
| | | activity | |

Only members of the Administrators and a Standard Activity Actions managers Group can manage the items in this list. Users Group members have “Read only” permissions.

### “Standard Activity Actions” List

### List Definition:

| Field | Data Type | Description | Behaviour |
|---|---|---|---|
| Title | Text | Will be pre-populated with Standard | |
| | | Activity Actions | |
| Description | Multiple | Description of the Action to be displayed | Hover popup on form |
| | lines of | on the page as part of the instructional | |
| | Text | methods | |
| Skill Sets | Lookup | Looks up the Skill Sets site column | |
| Standard | Lookup | Looks up the “Standard Activity” List | “Standard Activity Actions” |
| Activity | | | are categorised by “Standard |
| | | | Activities” |
| Display Order | Number | Used to control the order in which the | |
| | | Actions are displayed on the form. | |

Only members of the Administrators Group and the Standard Activity Actions Managers Group can manage the items in this list. Members of the Users Group have “Read only” permissions.

A referential relationship exists between this list and the “Standard Activities” List.

The “Standard Activity Actions” list must be instantiated after the “Standard Activities” List as this list has a dependency on the “Standard Activities” List. The dependency (relationship) exists on the “Standard Activity Actions: Standard Activity” field which requires a reference to the Lookup field “Standard Activities: Title” for valid values.

### “Standard Activity Action Choice” List

| Field | Data Type | Description | Behaviour |
|---|---|---|---|
| Title | Text | Choice value | |
| Standard | Lookup | Looks up the | “Standard Activity Action |
| Activity | | “Standard Activity | Choice” list items are |
| Action | | Action” List | categorised by “Standard |
| | | | Activity Actions” |

Only members of the Administrators Group and the Standard Activity Actions managers Group can manage the items in this list. Members of the Users Group have “Read only” permissions.

A referential relationship exists between this list and the “Standard Activity Actions” List.

The Standard Activity Action list must be after the “Standard Activity Actions” List as this list has a dependency on the “Standard Activity Actions” List. The dependency (relationship) exists on the “Standard Activity Action Choice: Standard Activity Action” field which requires a reference to the Lookup field “Standard Activity Actions: Title” for valid values.

These three are used to manage the standard tasks referred to above (“Standard Tasks”).

The relationship between these tables is a follows;

### “Tasks” List

The Tasks list provides most of the functionality of the task management function 5.

The Tasks list allows the use of two Content Types called “Ad-hoc Activity” and “Standard Activity”—depending upon whether it is an ad-hoc or standard task as described above. Custom behaviour is implemented to control which fields are enabled and disabled on Add and Edit forms (which are displayed to the user to add and/or edit information), so that items cannot be deleted from this list unless by an Administrator, this behaviour requires that the default forms are overridden for these Content Types tasks. By default, the Tasks list “Edit” permissions are turned off for all users so that only the user or group specified in the “Task Assigned To” field on the task creation forms 38, 39 can make changes to the task. Thus, once a new task has been created, only the queue owner for the queue specified in the “Task Assigned To” field can edit the task.

This is achieved by making sure that the following conditions must be checked on this field before allowing an update:
1. The users' account name must matches a Work Queue Management: Queue Owner of a Work Queue Management: Queue Name which equals the value in the “Task Assigned To” field;
2. If this field is blank when the edit form is loaded it means the original value for “Task Assigned To” field value in the “Work Queue Management” List has been removed, in this instance the user must assign another valid value.

A data access module facilitates access to the case management application database 15 via the user interface 7 to retrieve case management data as required and as mentioned above.

Users will create new “Standard” or “Ad-hoc” tasks from the Tasks list. These tasks will be implemented through three custom Content Types, two of which will be made available to users through this list:
1. Base task;
2. Standard task;
3. Ad-hoc task.

The “base task” will not be available to users: it will simply contain the base metadata common to both the “Standard” and “Ad-hoc” tasks.

The schema for each of the abovementioned Content Types can be found in the accompanying “Lists and Content Types Specifications” spreadsheet.

The “Task Assigned To” field is always validated against the “Work Queue Management: Queue Name” field prior to committing the update to ensure a valid value exists.

As mentioned above, to add a new standard activity by using the toolbar 35 or, for example, from the case management application 6 which may have a unique identifier (IRN) field in which the user can input the unique identifier.

When creating a new ad-hoc or standard task the unique identifier must be validated. This means that the unique identifier field must accept only:
1. A validated unique identifier (IRN) (via a case management database query) or match the exact string “new case”. If the unique identifier value supplied is a valid and not “new case”, the task form 38, 39 (Standard and Ad-hoc) will pre-populate the “Add New” form fields in the table below; or
2. If the exact text is “new case”, the form will be left blank for user data entry.

Fields which are pre-populated on a successful lookup and validation are:

| Field | Source | Description | Visibility |
|---|---|---|---|
| Required By | Case management | Default value | Visible |
| | database 15 | | |
| Business Area | Case management | Default value | Visible |
| | database 15 | | |
| Date Required | Current Date | Plus 3 days from current date | Visible |
| Task Assigned To | Default Assigned To | Looks up a default value from the “Default | Visible |
| | Person list | Assigned To Person” list according the pre- | |
| | | populated “Required By” field. | |
| Multiple Owner Flag | Case management | Data used for reporting and unique identifier | Hidden |
| | database field | confirmations | |
| Case Owner | Case management | Data used for reporting and unique identifier | Hidden |
| | database field | confirmations | |
| Case Title | Case management | Data used for reporting and unique identifier | Hidden |
| | database field | confirmations | |
| Case Responsible FE | Case management | Data used for reporting and unique identifier | Hidden |
| | database field | confirmations | |
| Case Acting FE | Case management | Data used for reporting and unique identifier | Hidden |
| | database field | confirmations | |
| Debtor | Case management | Data used for reporting and unique identifier | Hidden |
| | database field | confirmations | |
| Country | Case management | Data used for reporting and unique identifier | Hidden |
| | database field | confirmations | |
| Property | Case management | Data used for reporting and unique identifier | Hidden |
| | database field | confirmations | |
| Category | Case management | Data used for reporting and unique identifier | Hidden |
| | database field | confirmations | |
| Subtype | Case management | Data used for reporting and unique identifier | Hidden |
| | database field | confirmations | |
| Basis | Case management | Data used for reporting and unique identifier | Hidden |
| | database field | confirmations | |

If the supplied unique identifier is “new case” the form will be left completely blank for user data entry, in this case some hidden fields will not be populated on the Add event. It is expected that a “new case” List item may eventually be assigned a valid unique identifier on a subsequent Edit event.

The value “new case” can remain the value in this field on subsequent edit actions, on these Edit actions the unique identifier field will be enabled with a “Validate IRN” button next to the field. This is to allow the user to enter a unique identifier and validate it against the case management database 15 as per the procedure on an “Add New” action described above.

The Standard Task creation form 38 will be loaded incrementally as the user selects various options from particular fields, the data entry fields for the “Standard Activity Task” should be displayed in the following order:

| Field | Data Type | Lookup List/Values | Required | Behaviour |
|---|---|---|---|---|
| Required By | Lookup | Users Group | Y | Default to user assigned to cas [symbol] |
| | | | | selected |
| Business Area | Lookup | Business Area Site | Y | Dropdown list of options, but defa [symbol] |
| | | Column | | to business areas handling t [symbol] |
| | | | | relevant case. |
| | | | | Perform custom code lookup on t [symbol] |
| | | | | Site column to provide default valu [symbol] |
| Case Type | Lookup | Case Type Site | Y | Dropdown list |
| | | Column | | |

[symbol]

indicates data missing or illegible when filed

The selection of the “Case Type” field determines the default values populated in the options displayed in a second portion of the Standard Task Creation form 38 of the “Add New” form.

The following fields in the second portion of the form will be displayed in the following order:

| Field | Data Type | Lookup List/Values | Required | Behaviour |
|---|---|---|---|---|
| Standard Activity | Lookup | Standard Activities | Y | Filter items by the selected “Cas [symbol] |
| | | | | Type” |
| | | | | Default to first applicable entry. |
| Date Required | Date | | Y | Default to current date + 3 busines [symbol] |
| | | | | days |
| Task Priority | Choice | Urgent | Y | Dropdown list, |
| | | High | | Default is “Medium” |
| | | Medium | | |
| | | Low | | |
| Task Assigned | Lookup | Default Assigned | Y | Must be a member of the Users |
| To | | To Person | | Group |
| | | | | Must exist in the “Work Queue |
| | | | | Management: Queue Name” |
| | | | | field |
| Task Status | Choice | New | Y | Default to “New” |
| | | In Progress | | |
| | | Completed | | |
| | | Deferred | | |
| | | Closed | | |
| | | Cancelled | | |

[symbol]

indicates data missing or illegible when filed

A default “Standard Activity” will be displayed as the first option in the Standard Activity dropdown list which will cause the rest of the form to populate with the relevant “Standard Activity Action” items with their related “Standard Activity Action Choice” choices (if applicable). The “Standard Activity Actions” will be listed down the form in the order specified in the lists' “Display Order” field. Each of these items will render in a different colour to highlight the fact that when the item is “moused over” a dhtml popup will appear with content from the “Description” field.

In the second segment of the standard task creation form 34, when the user changes the selected “Standard Activity” option in the dropdown-list, the page will post back and display the new set of related “Standard Activity Action” items.

Some “Standard Activity Action” items (not all) will have a related set of options which are stored in the “Standard Activity Action Choice” List. These “choices” will always be available in a dropdown-list and will be automatically generated when the “Standard Activity Action” items are generated on the form.

| | | | | |
|---|---|---|---|---|
| Standard Activity | Lookup | Standard Activity | N | Action Choices are displayed an [symbol] |
| Action Choice | | Action Choice | | filtered by the selected “Standar [symbol] |
| | | | | Activity” |
| Instructions | Text | | N | Append only text field, 15 lines f [symbol] |
| | | | | data entry |
| Attachments | Attachment | | N | User can attach multiple documents |

[symbol]

indicates data missing or illegible when filed

If the value for this field is “Closed” or “Cancelled”, the form can only be submitted if any of the following conditions is true:
The “Task Assigned To” field is the same as the “Required By” field;
The “Task Assigned To” field is the same as the “Created By” field.

“ActionsOptionsValues” and “ActionsOptionsText” fields are required to ensure the “Standard Activity Action” and the corresponding “Standard Activity Action Choice” selected values are recorded in each “Standard Task” list item created by a user.

These fields hold delimited values (by “,” commas) corresponding the chosen Actions and Choices for a “Standard Task” list item. These values will be retrieved and parsed to ensure the correct Choices for Actions are displayed correctly for each next “Edit” action.

ActionsOptionsValues will be the following field “ID” values from their parent lists as specified;

| | Standard Activity | Standard Activity |
|---|---|---|
| Sort Order | Action: ID | Action Choice: ID |
| 1 | 23 | 2 |
| 2 | 41 | 343 |
| 3 | 232 | 44 |

And stored on separate lines in the field in the following format:

1,23,2
2,41,343
3,232,44

ActionsOptionsText will apply the same as for “ActionsOptionsValues” field except that the actual text values will be recorded for each of the Actions and Choices in this field. The text values are the “Title” field values from the parent list, therefore to match the text values would be like this:

| | Standard Activity | Standard Activity |
|---|---|---|
| Sort Order | Action: Title | Action Choice: Title |
| 1 | Registration Fee | DO NOT Pay Registration Fee |
| 2 | Signature? | No Signature |
| 3 | Secretarial to post? | Via Post |

And stored on separate lines in the field in the following format:

### 1, Registration Fee=DO NOT Pay Registration Fee

### 2, Signature?=No Signature

3, Secretarial to post=Via Post

Changes to these values will be recorded in version history to allow users to see changes to Actions and Choices over subsequent “Edit” actions. If an Action or Choice is removed from its parent List, the user will be notified on the next “Edit” action that the original value no longer exists.

For editing a standard task the user selects the required task displayed in the appropriate view i.e. webpage. This displays an edit standard task form 36, which has a number of fields which can be edited (depending upon the permissions of the user). The fields for the edit standard activity task” form 36 will be displayed in the following order:

| Field | Data Type | Lookup List/Values | Required | Behaviour/Protection Rules |
|---|---|---|---|---|
| IRN | Text | | Y | Disabled |
| | | | | More business rules apply |
| | | | | (see below) |
| Required By | Lookup | “TMS Users” | Y | Disabled unless |
| | | SharePoint Group | | “Assigned To” = |
| | | | | “Required By” |
| | | | | Must be a member of |
| | | | | the Users Group |
| Business Area | Lookup | Business Area | Y | Disabled unless “Assigned |
| | | Site Column | | To” = “Required By” |
| Case Type | Lookup | Case Type Site | Y | Disabled unless “Assigned |
| | | Column | | To” = “Required By” |
| Standard Activity | Lookup | Standard | Y | Disabled unless “Assigned |
| | | Activities | | To” = “Required By” |
| | | | | Options filtered by the |
| | | | | selected “Case Type” |
| Date Required | Date | | Y | Disabled unless “Assigned |
| | | | | To” = “Required By” |
| Task Priority | Choice | Urgent | Y | Dropdown list |
| | | High | | Disabled unless “Assigned |
| | | Medium | | To” = “Required By” |
| | | Low | | |
| Task Assigned To | Lookup | Default Assigned | Y | Enabled |
| | | To Person | | Must be a member of |
| | | | | the Users Group |
| | | | | Must exist in the “Work |
| | | | | Queue Management: |
| | | | | Queue Name” field |
| Task Status | Choice | New | Y | Enabled - Dropdown list |
| | | In Progress | | Form submissions rules |
| | | Completed | | apply depending on the |
| | | Deferred | | selected value (see below). |
| | | Closed | | |
| | | Cancelled | | |
| Instructions | Text | | N | Enabled - Append Only |
| ActionsOptionsValues | Text | | Y | Stores the sort order and |
| | | | | “ID” values form the |
| | | | | “Standard Activity Action” |
| | | | | and “Standard Activity |
| | | | | Action Choice” lists to keep |
| | | | | a reference to the relevant |
| | | | | selected options from those |
| | | | | lists for the next Edit action. |
| ActionsOptionsText | Text | | Y | Stores the sort order, and |
| | | | | “Title” values form the |
| | | | | “Standard Activity Action” |
| | | | | and “Standard Activity |
| | | | | Action Choice” lists to keep |
| | | | | a reference to the relevant |
| | | | | selected options from those |
| | | | | lists for the next Edit action. |
| Attachments | | | N | User to attach any number |
| | | | | of documents from the |
| | | | | network |

Validate all field entries as specified above in the “Behaviour” column and implement the following conditions.

If the selected value for “Task Status” is Closed or Cancelled, the form can only be submitted if either of the following conditions is true:
The “Task Assigned To” field is the same as the “Required By” field;
The “Task Assigned To” field is the same as the “Created By” field.

In the case that a Standard Activity (Standard Activities List) is no longer required or is invalid, the “Standard Activities: Is Valid” field will have a value of “False”. In this case, on the next TMS task edit the following will occur:
A message will be displayed on the form indicating that the selected “Standard Activity” is no longer valid and that the task must be reassigned to the “Required By” person;
The “Task Assigned To” field will automatically be updated with the value from the “Required By” field;
The user must submit the form to reassign the task.

This behaviour will also occur if a Standard Activity is deleted from the “Standard Activities” List.

The field in which the unique identifier is input/displayed must be disabled on all subsequent “Edit” actions excepting only when the value is “new case”. Only when this condition is true can the user either leave the value as “new case” or enter a new unique identifier (IRN) value and go through the usual validation process as outlined previously in this document except that it should not override any non-hidden values on the form i.e. Required By and Business Area.

When creating a new ad-hoc task using the ad-hoc task creation form 34, the same lookup and validation rules apply as specified above for creating a standard activity task.

The data entry fields for the ad-hoc task creation form 34 should be displayed in the following order:

| Field | Data Type | Lookup List/Values | Required | Behaviour |
|---|---|---|---|---|
| Required By | Lookup | Users Group | Y | Default to user |
| | | | | responsible for case |
| Business Area | Choice | Business Areas Site | Y | Dropdown list of options, |
| | | Column | | but default to business |
| | | | | area responsible for |
| | | | | case |
| | | | | Perform custom code |
| | | | | lookup on the Site |
| | | | | column to provide |
| | | | | default value. |
| Date Required | Date | | Y | Default to today + 3 |
| | | | | business days |
| Task Priority | Choice | Urgent | Y | Dropdown list |
| | | High | | Default to “Medium” |
| | | Medium | | |
| | | Low | | |
| Task Assigned To | Lookup | Default Assigned To | Y | Must be a member |
| | | Person | | of the Users Group |
| | | | | Must exist in the |
| | | | | “Work Queue |
| | | | | Management: |
| | | | | Queue Name” field |
| Task Status | Choice | New | Y | Dropdown list, Default to |
| | | In Progress | | “New”. |
| | | Completed | | Form submissions rules |
| | | Deferred | | apply depending on the |
| | | Closed | | selected value (see |
| | | Cancelled | | below). |
| Inprotech Update | Choice | Yes/No | Y | Yes/No Checkbox |
| Required | | | | If Yes, allow data entry |
| | | | | into associated |
| | | | | Instructions for case |
| | | | | management system |
| | | | | (i.e. Inprotech). |
| Inprotech | Text | | | Append Only |
| Instructions | | | | Comments. |
| | | | | Display 4 lines for data |
| | | | | entry. |
| | | | | Must be filled in if the |
| | | | | field “Inprotech Update” |
| | | | | is “Yes” |
| Case Type | Lookup | Case Types Site | N | |
| | | Column | | |
| Inprotech Due | Date | | N | Leave blank |
| Date | | | | |
| Degree of | Choice | 1 | N | Dropdown list |
| Difficulty | | 2 | | Form comments: “1 |
| | | 3 | | Easy, 4 hard” |
| | | 4 | | |
| Ad-hoc Action | Choice | Letter to Client | N | Checkboxes, multiple |
| | | Letter to Associate | | values can be selected. |
| | | Letter to IPO | | “Specify own value” |
| | | File Note | | means this field can |
| | | Specify own value | | potentially contain many |
| | | | | different values |
| Delivery method | Choice | Fax | N | Checkboxes, multiple |
| for Original | | Email | | values can be selected. |
| | | Post | | If “Fax” is selected, |
| | | Courier | | allow entry of fax |
| | | | | number |
| | | | | If “Email” is selected, |
| | | | | allow entry of email |
| | | | | address |
| Email Address | Text | | N | |
| Fax Number | Text | | N | |
| Instructions | Text | | N | Append Only Comments |
| | | | | Display 10 line for data |
| | | | | entry. |
| Attachments | | | Y | User to attach any |
| | | | | number of documents |
| | | | | from the network. |

If the selected value for “Task Status” is Closed or Cancelled, the form may be submitted if the following condition is true:
The “Task Assigned To” field is the same as the “Required By” field.

As described above in respect of standard tasks can be edited (if the user has the appropriate permissions). In this case an edit ad-hoc task form is displayed to the user and the appropriate fields can be edited (as required and available and subject to permissions). The ad-hoc task form fields should be displayed in the following order:

| Field | Data Type | Lookup List/Values | Required | Behaviour/Protection Rules |
|---|---|---|---|---|
| IRN | Single Text | | Y | Disabled |
| Required By | Lookup | Users Group | Y | Disabled unless “Task |
| | | | | Assigned To” = “Required |
| | | | | By” |
| Business Area | Lookup | Business Area site | Y | Disabled unless “Task |
| | | column | | Assigned To” = “Required |
| | | | | By” |
| Date Required | Date | | Y | Disabled unless “Task |
| | | | | Assigned To” = “Required |
| | | | | By” |
| Task Priority | Choice | Urgent | Y | Disabled unless “Task |
| | | High | | Assigned To” = “Required |
| | | Medium | | By” |
| | | Low | | |
| Inprotech | Choice | Yes/No | Y | Enabled |
| Update | | | | Yes/No Checkbox |
| Required | | | | If Yes, allow data entry |
| | | | | into associated Inprotech |
| | | | | Instructions. |
| | | | | If changed, user must |
| | | | | specify explanation for |
| | | | | change |
| Inprotech | Text | | | Enabled - Append Only |
| Instructions | | | | Append Only Comments |
| | | | | Display 4 lines for data |
| | | | | entry. |
| | | | | Must be filled in if the field |
| | | | | “Inprotech Update” is |
| | | | | “Yes” |
| Case Type | Lookup | Case Type site | N | Enabled |
| | | column | | |
| Inprotech Due | Date | | N | Enabled |
| Date | | | | |
| Degree of | Choice (one | 1 | N | Enabled |
| Difficulty | only) | 2 | | Dropdown list |
| | | 3 | | |
| | | 4 | | |
| Action | Choice | Letter to Client | N | Enabled |
| | | Letter to Associate | | Checkboxes |
| | | Letter to IPO | | Allow the selection of |
| | | | | multiple choices |
| | | File Note | | |
| | | Specify own | | |
| | | value | | |
| Delivery method | Choice | Fax | N | Enabled |
| for Original | (multiple) | Email | | Checkboxes |
| | | Post | | Allow multiple selections |
| | | Courier | | If “fax” is selected, allow |
| | | | | entry of fax number |
| | | | | If “Email” is selected, |
| | | | | allow entry of email |
| | | | | address |
| Email Address | Text | | N | Enabled |
| Fax number | Text | | N | Enabled |
| Task Assigned | Lookup | Default Assigned To | Y | Enabled |
| To | | Person | | Must be a member of |
| | | | | the “TMS Users” |
| | | | | SharePoint Group |
| | | | | Must exist in the |
| | | | | “Work Queue |
| | | | | Management: Queue |
| | | | | Name” field |
| Task Status | Choice | New | Y | Enabled |
| | | In Progress | | Dropdown list |
| | | Completed | | Form submissions rules |
| | | Deferred | | apply depending on the |
| | | Closed | | selected value (see |
| | | Cancelled | | below). |
| Instructions | Append Only | | N | Enabled |
| | Comments | | | |
| Attachments | | | | Allow user to attach and |
| | | | | detach any number of |
| | | | | documents to/from the |
| | | | | task |

If the selected value for “Task Status” is Closed or Cancelled, the form can only be submitted if either of the following conditions is true:
The “Task Assigned To” field is the same as the “Required By” field;
The “Task Assigned To” field is the same as the “Created By” field.

When a user profile is removed from a site collection, references in any Lists'“Person” Lookup field will show up as empty on the next “Edit” action. This List item field however remains the originally specified value until the next edit. The same behaviour applies to a List referencing another Lists' list item as a Lookup field.

This scenario may occur if a user is not a member of the Users Group which is used as the Person lookup field for the “Required By” field; and if a list item is removed from the “Default Assigned To Person” List which is used by the “Task Assigned To” field.

List items in a Lookup List should not be deleted if possible, but instead modified to a different suitable value, else all related List items will need to be updated manually.

In the instance where the “Required By” field is no longer valid i.e. if the user is not a member of the Users Group, the task management function 5 will check if the field value is missing and notify the user if it is. The form cannot be submitted unless a new valid value is supplied for the “Required By” field.

The functionality that enables rule validation and manages data access to the case management application 6 can be implemented using any suitable software. In the present embodiment, this is done using Microsoft Enterprise Library 4.0 application blocks.

Every distinct “Queue Name” in the “Work Queue Management” List will have an associated view, the “Queue Name” field will always map to the “TMS tasks: Task Assigned To” field meaning all views will be based on the “TMS tasks” List.

As has been referred to above, members of the Users Group will always have access to all Views based on the Tasks List, however Views most relevant to the current user will be displayed in the navigation.

By default this means every user can view other users' assigned tasks, however a user still cannot modify any task which has not been assigned to them.

This could therefore allow for the following situations:
1. Person A can read access to Person B's three views because they are away sick;
2. A supervisor will have access to a junior's view.

As also mentioned above, there can be multiple owners of some queues. For example, to achieve assigning multiple users to the queue “Accounts”, create multiple list items in the “Work Queue Management” List where the “Queue Name” field is “Accounts” and a different user account name is specified in “Queue Owner” field as follows:

| Queue Name | Queue Owner |
|---|---|
| Accounts | michaelv |
| Accounts | laink |
| Accounts | andyc |

The Task data will be displayed as columns in the following order across the screen:

| Column | Notes |
|---|---|
| Task No. | Renamed from “Title” in the “TMS tasks” schema. |
| | Context menu will be attached to this field to allow |
| | the user to drill down or manage the list item. |
| Attachments Icon | |
| IRN | |
| Case Owner | |
| Case Acting | |
| Case Type | |
| Standard Activity | |
| Action | |
| Required by | |
| Date Required | |
| Priority | |
| Task Status | |
| Created | |
| Created by | |

Tasks will be sorted by the “Required By Date” with the earliest at the top. Secondary sort order will be the “Task Priority” field.

Task items where the “Task Status” field equals “Closed” or “Cancelled” are excluded.

The following Task items with the following conditions will be rendered as specified:
Overdue—Task shown in Red
Due Today—Task shown in Orange
Due Tomorrow—Task shown in Blue
All Others—Task shown in Black

In the “Required By” view, the Task data will be displayed as columns in the following order across the screen:

| Field | Notes |
|---|---|
| Task No. | Renamed from “Title” in the “TMS tasks” schema. |
| | Context menu will be attached to this field to allow |
| | the user to drill down or manage the list item. |
| Attachments Icon | |
| IRN | |
| Case Owner | |
| Case Acting | |
| Case Type | |
| Standard Activity | |
| Action | |
| Assigned To | |
| Date Required | |
| Priority | |
| Task Status | |
| Created | |
| Created by | |

Apart from Task No. no other field should have drill through to either the task or any other list.

The list should be sorted into Required By date order with the earliest at the top. Within a particular date the second sort order should be Priority.

Tasks with a Task Status=Closed or Cancelled are excluded.

Highlight tasks with the following attributes:
Overdue—Show task in Red
Due Today—Show task in Orange
Due Tomorrow—Show task in Blue
All Others in Black

### Closed Tasks for Queue Owner View

The “Closed Tasks” view is displayed as columns in the following order across the screen:

| Field | Notes |
|---|---|
| Task No. | Renamed from “Title” in the “TMS tasks” schema. |
| | Context menu will be attached to this field to allow the |
| | user to drill down or manage the list item. |
| Attachments Icon | |
| IRN | |
| Case Owner | |
| Case Acting | |
| Case Type | |
| Standard Activity | |
| Action | |
| Assigned To | |
| Date Required | |
| Priority | |
| Task Status | |
| Created | |
| Created by | |

The list should be sorted into Last Modified date order with the newest at the top. Only Tasks with a Task Status=Closed or Cancelled should be included. Highlight tasks with the following attributes:
Tasks where last Modified date>today−7 days—Show task in Grey
All others in Black

The “Recent Changes” view is displayed as follows:

| Column | Notes |
|---|---|
| Task No. | Renamed from “Title” in the “TMS tasks” schema. |
| | Context menu will be attached to this field to allow |
| | the user to drill down or manage the list item. |
| Attachments Icon | |
| IRN | |
| Case Owner | |
| Case Acting | |
| Case Type | |
| Standard Activity | |
| Action | |
| Required by | |
| Date Required | |
| Priority | |
| Task Status | |
| Modified | |
| Modified By | |
| Created | |
| Created by | |

This view is to allow the user to see what has been assigned to them recently Display in Modified Date order with newest at the top

Include only rows with “Modified By” not=[me]

The tasks can be displayed by unique identifier in a “Tasks assigned to IRN (unique identifier)” view.

This view can also be accessed from the user interface 7 where the unique identifier will be passed as a parameter in the URL. The list should be displayed without asking for the IRN entry.

### View Definition:

| Field | Notes |
|---|---|
| Task No. | Renamed from “Title” in the “TMS tasks” schema. |
| | Context menu will be attached to this field to allow |
| | the user to drill down or manage the list item. |
| Attachments Icon | |
| IRN | |
| Case Owner | |
| Case Acting | |
| Case Type | |
| Standard Activity | |
| Action | |
| Required By | |
| Assigned To | |
| Date Required | |
| Priority | |
| Task Status | |
| Created | |
| Created by | |

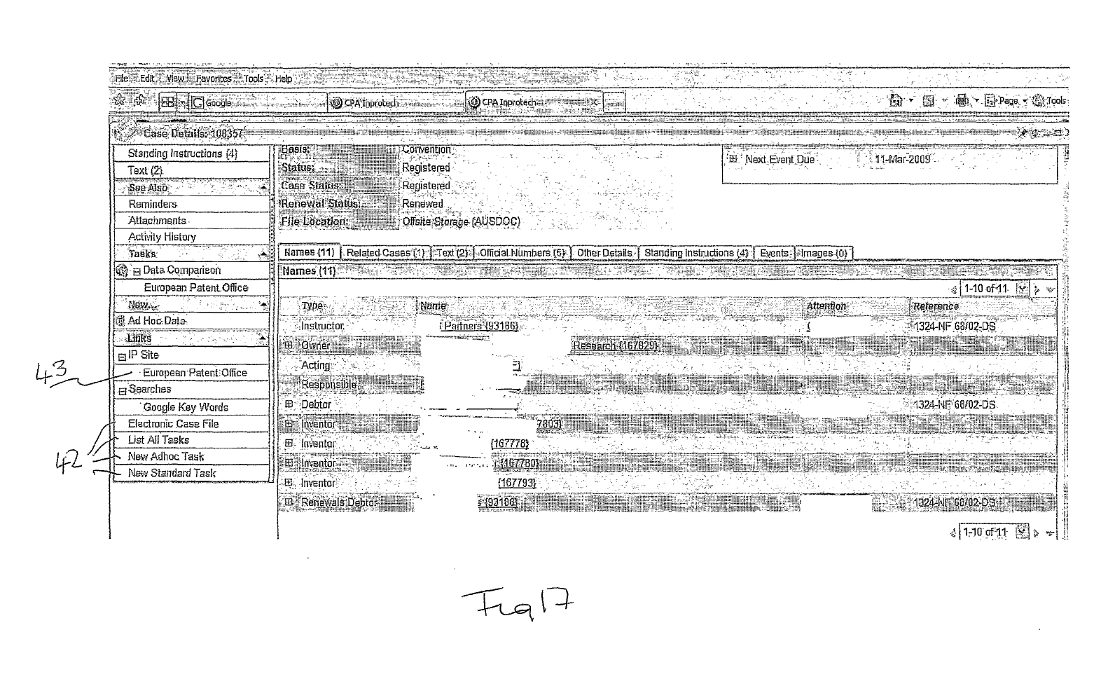

Both the electronic case file function 3 and the task management function 5 can be accessed from the case management application 6. FIG. 17 illustrates a view of a selected case in the case management application 6. Links 42 are provided in link pane 43 to the task management function 5 and the case management function 3.

A delegation function 11 is also provided as part of the content and process application 2. In the embodiment described herein, the delegation function 11 is provided using SharePoint—in the same way as the task management and electronic case file functions.

In the delegation function 11, users are able to ‘drag and drop’ emails from their email application 9 into a specific delegated work folder 44 provided in the email application folder structure (see FIG. 2). This is done using the mail integration application 8 which therefore uploads the email to the delegation function 11.

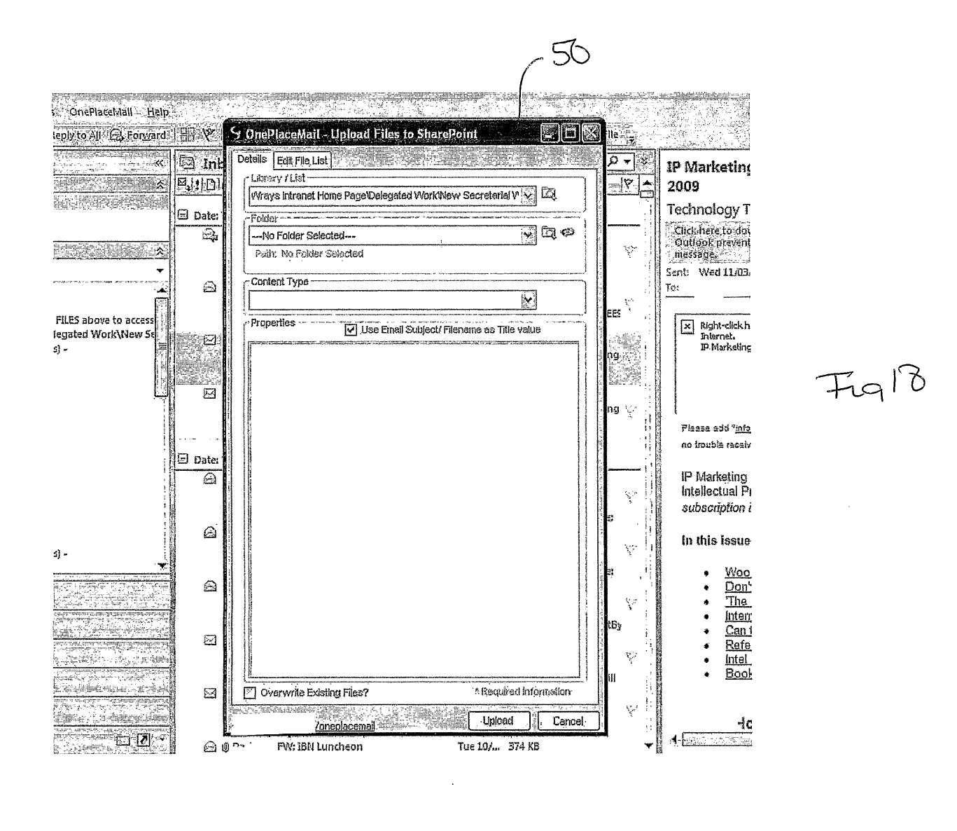

As described above in respect of the electronic case file function 3, as the email is uploaded to the delegation function, a pop up window 50 is presented to the user (see FIG. 18) which enables the user to input instructions or further information).

In this way, the email is actually moved to this delegated work folder 44. Users can then access these emails via the delegation function 11. The delegation function is accessed via a tab 45 in the web browser in the same way as the electronic case file function 3 and task management function 5 is accessed.

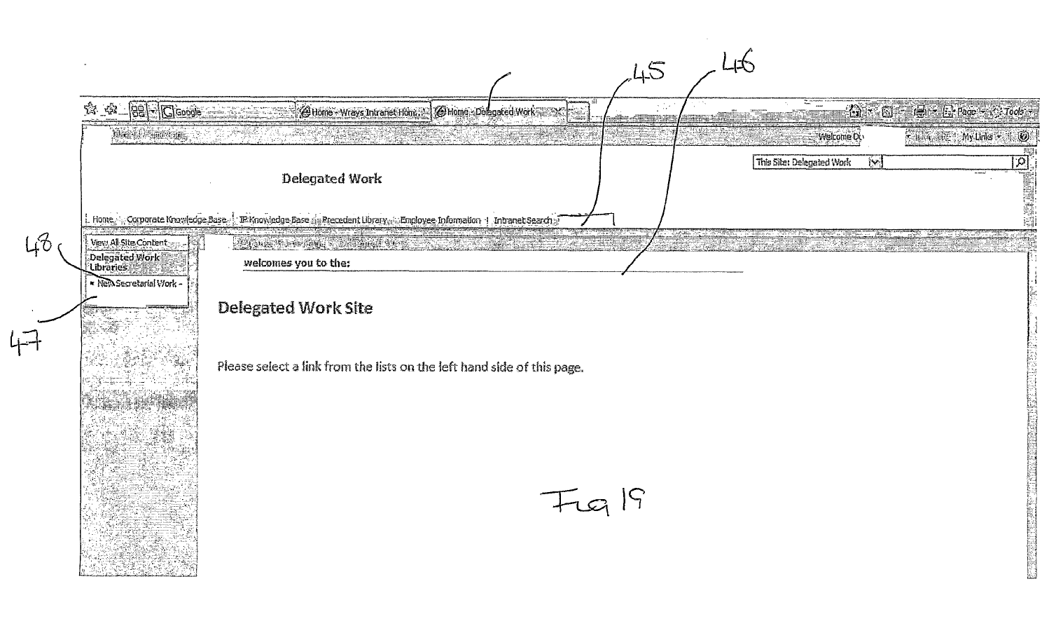

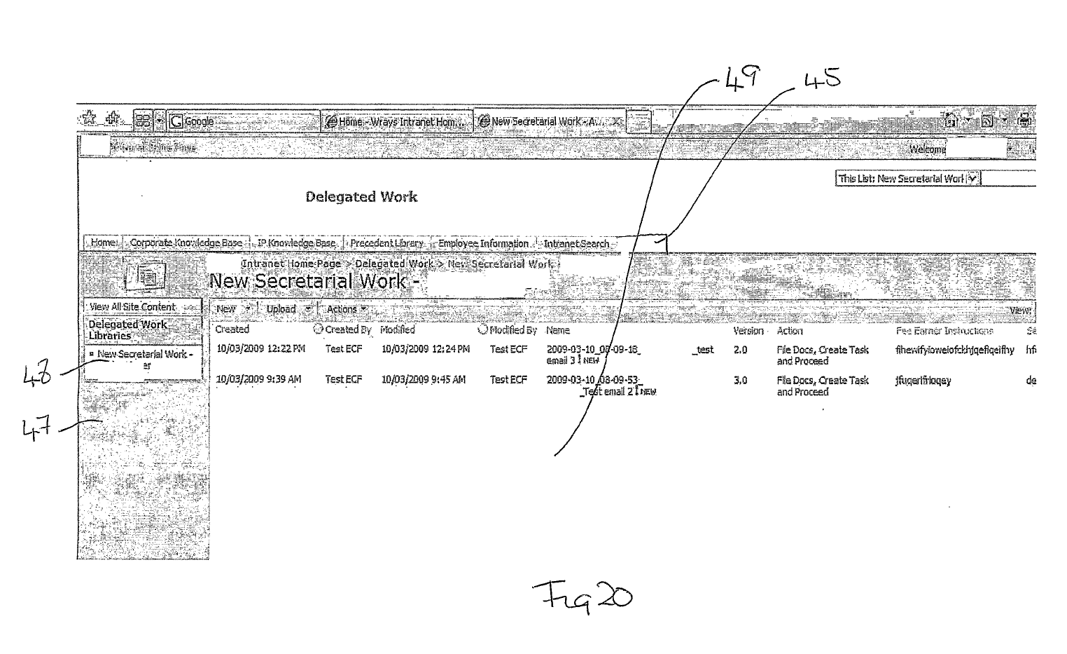

The delegated work function 11 has a welcome page 46 (FIG. 19) with a side viewing pane 47 which includes the available delegated work views 48. Selecting the required view will open up a new delegated work view 49 for the required user—see FIG. 20. This will include all the delegated emails transferred from the email application 9 to the delegation function 11 as described above.

The user can then view details of the uploaded email, including the instructions input by the user who uploaded the email to the delegation function 11 by the pop up window 50 as well as the email itself 51. When the required instructions have been completed, then the task can be marked as process or complete and these can be viewed as ‘processed’.

Although described in relation to the work of a patent attorney firm, it will be understood that the present invention could be applied and varied to suit other uses such as for use by law firms, accounting firms and other professional services firms with appropriate modification to suit the user requirements.

It will be appreciated by those skilled in the art that variations and modifications to the invention described herein will be apparent without departing from the spirit and scope thereof. The variations and modifications such as would be apparent to persons skilled in the art are deemed to fall within the broad scope and ambit of the invention as herein set forth.

The claims defining the invention are as follows:

1. An electronic case file and document management system stored on a server having one or more remote terminals coupled thereto, the case file and document management system comprising: a content and process application, a case management application, an email application and a mail integration application, wherein the content and process application is operable to provide an electronic case file function for storing and facilitating the display of data relating to one or more cases, and a task management function for creating and displaying data relating to tasks for the one or more cases, the remote terminals being arranged to access the electronic case file function, the task management function, the email application and the case management application for operation of the electronic case file and document management system.

2. The electronic case file and document management system of claim 1, wherein the data comprises electronic documentation.

3. The electronic case file and document management system of claim 1 or 2, wherein the case management application is coupled to a case management database, the case management database being arranged to store data relating to each case, and each case being identified by a unique identifier in the case management application.

4. The electronic case file and document management system of claim 3, wherein the electronic case file function is configured to store documentation in a folder structure comprising a plurality of folders, each folder having the unique identifier.

5. The electronic case file and document management system of claim 4, wherein each folder relates to a case and is associated with the related case by the unique identifier of the related case.

6. The electronic case file and document management system of claim 4 or 5, wherein the electronic case file function is operable to carry out a verification of the unique identifier prior to storing the documentation in the respective folder.

7. The electronic case file and document management system of any one of claims claim 4 or 6, wherein the email application is coupled to an email integration application and is operable to transfer emails stored and displayed by the email application to the electronic case file function in a selected one or more of the folders.

8. The electronic case file and document management system of any one of the preceding claims, wherein the task management function is operable to perform an action in respect of one or more tasks relating to one or more of the cases, including creating, editing and/or displaying one or more tasks relating to one or more of the cases.

9. The electronic case file and document management system of claim 8, wherein the tasks are stored in work queues with one or more users of the system being assigned as owners of the work queues.

10. The electronic case file and document management system of claim 8 or 9, wherein tasks are created by a user and are assigned to users of the system which may or may not be the person who created the task.

11. The electronic case file and document management system of any one of the preceding claims, wherein the documentation stored in the content and process application can be viewed by users of the system via the remote terminals.

12. The electronic case file and document management system of claim 11, wherein the remote terminals include an interface for viewing documentation stored in the electronic case file function.

13. The electronic case file and document management system of claim 13, wherein the interface further enables a user to perform an action in respect of one or more tasks, including creating, editing and/or viewing one or more tasks.

14. The electronic case file and document management system of claim 14, wherein tasks can be sorted and viewed by criteria including one or more of: their creator, the person to whom the task is assigned, and/or by the unique identifier for the case to which the task relates.

15. A method for storing documents and managing tasks associated with a case, the method comprising using an electronic case file function and a task management function provided by a content and process application stored on a server and accessible by a user with a remote terminal coupled to the server, the electronic case file function being arranged to store and facilitate the display of data relating to one or more cases, and the task management function being arranged to create and display data relating to tasks for the one or more cases.

16. The method of claim 15, wherein the data comprises electronic documentation.

17. The method of claim 15 or 16, wherein the case management application is coupled to a case management database, the case management database being arranged to store data relating to each case, and each case being identified by a unique identifier in the case management application.

18. The method of claim 17, comprising storing documentation in a folder structure via the electronic case file function, the folder structure comprising a plurality of folders, each folder having the unique identifier.

19. The method of claim 18, wherein each folder relates to a case and is associated with the related case by the unique identifier of the related case.

20. The method of claim 18 or 19, comprising carrying out a verification of the unique identifier prior to storing the documentation in the respective folder.

21. The method of any one of claims 18 to 20, comprising transferring emails stored and displayed in an email application, and coupled to an email integration application, to the electronic case file function in a selected one or more of the folders.

22. The method of any one of claims 15 to 21, comprising performing an action in respect of one or more of the cases using the task management function, including creating, editing and/or displaying one or more tasks relating to one or more of the cases.

23. The method of claim 22, comprising storing tasks in work queues with one or more users of the system being assigned as owners of the work queues.

24. The method of claim 22 or 23, wherein tasks are created by a user and are assigned to users of the method which may or may not be the person who created the task.

25. The method of any one of claims 15 to 24, wherein the documentation stored in the content and process application can be viewed by users of the method by means of the remote terminals.

26. The method of claim 25, wherein the remote terminals include an interface for viewing the documents stored in the electronic case file function.

27. The method of claim 22, wherein the interface enables a user to perform an action in respect of one or more tasks, including creating, editing and/or viewing one or more tasks.

28. The method of claim 27, wherein the tasks are sorted and viewed by criteria, including one or more of: their creator, the person to whom the task is assigned, and/or by the unique identifier for the case to which the task relates.

29. A management system stored on a server having one or more remote terminals coupled thereto, the management system comprising: a content and process application, a case management application, an email application and a mail integration application, wherein the content and process application is operable to provide an electronic case file function for storing and facilitating the display of data relating to one or more cases, and a task management function for creating and displaying data relating to tasks for the one or more cases, the remote terminals being arranged to access the electronic case file function, the task management function, the email application and the case management application for operation of the management system.

30. A system comprising a computer processor and a storage medium, the storage medium having a first software application and a second software application stored thereon, wherein the processor is operable:
under control of the first software application, to receive data relating to a record and to store the received data in a database associated with the first software application, the record including a unique identifier; and
under control of the second software application, to reference the record via the unique identifier.

31. The system of claim 30, wherein the processor is operable under control of the second software application to retrieve data relating to the record referenced via the unique identifier.

32. The system of claim 30 or 31, wherein the record relates to a case or a matter.

33. The system of any one of claims 30 to 32, wherein the first software application comprises a case management application, and the second software application comprises a content and process application, and the processor is operable under control of the content and process application to provide an electronic record file function for storing and facilitating the display of data relating to one or more records via an interface, and a task management function for creating and displaying via the interface data relating to tasks for the one or more records.

34. The system of claim 33, wherein the electronic case file function is configured to store documentation in a folder structure comprising a plurality of folders, each folder having the unique identifier.

35. The system of claim 34, wherein each folder relates to a record and is associated with the related record by the unique identifier of the related record.

36. The system of claim 34 or 35, wherein the processor is operable under control of the electronic case file function to carry out a verification of the unique identifier prior to storing the documentation in the respective folder.

37. The system of any one of claims 34 to 36, wherein the system comprises an email software application coupled to an email integration application and the processor under control of the email integration application is operable to transfer emails stored and displayed by the email application via the interface to the electronic case file function in a selected one or more of the folders.

38. The system of any one of claims 33 to 37, wherein the processor is operable under control of the task management function to perform an action in respect of one or more tasks relating to one or more of the records, including creating, editing and/or displaying one or more tasks via the interface.

39. The system of claim 38, wherein the processor is operable under control of the task management function to store the tasks in work queues and to assign one or more users of the system as owners of the work queues.

40. The system of any one of claims 33 to 39, wherein the processor is operable under control of the task management function to enable tasks to be sorted and viewed via the interface by criteria, including one or more of: their creator, the person to whom the task is assigned, and/or by the unique identifier for the case to which the task relates.

41. A method for integrating a first software application and a second software application, the first software application associated with a database storing data relating to a record, the method comprising:
identifying the record by a unique identifier; and
using the unique identifier in the second software application to reference the record.

42. The method of claim 41, comprising retrieving data relating to the record referenced via the unique identifier.

43. The method of claim 41 or 42, wherein the record relates to a case or a matter.

44. A method of allowing a first software application to access data stored in a database which is associated with a second software application, the database comprising a set of records, each record including a unique identifier, the method comprising:
allowing the first software application and the second software application to access a particular record by entering the unique identifier for that record into the application;
retrieving data associated with the record from the database; and
loading the retrieved data into the application.

45. The method of claim 44, wherein the record relates to a case or a matter.

46. A computer-readable storage medium on which is stored instructions that, when executed by a computer, cause the computer to perform the method for storing documents and managing tasks associated with a case according to any one of claims 15 to 28.

47. A computer programmed to carry out the method for storing documents and managing tasks associated with a case according to any one of claims 15 to 28.

48. A computer-readable storage medium on which is stored instructions that, when executed by a computer, cause the computer to perform the method for integrating a first software application and a second software application according to any one of claims 41 to 43.

49. A computer programmed to carry out the method for integrating a first software application and a second software application according to any one of claim 41 or 43.

50. A computer-readable storage medium on which is stored instructions that, when executed by a computer, cause the computer to perform the method of allowing a first software application to access data stored in a database which is associated with a second software application according to claim 44 or 45.

51. A computer programmed to carry out the method of allowing a first software application to access data stored in a database which is associated with a second software application according to claim 44 or 45.

52. An electronic case file and document management system substantially as hereinbefore described with reference to the accompanying drawings.

53. A method for storing documents and managing tasks associated with a case substantially as hereinbefore described with reference to the accompanying drawings.

54. A management system substantially as hereinbefore described with reference to the accompanying drawings.

55. A system substantially as hereinbefore described with reference to the accompanying drawings.

56. A method for integrating a first software application and a second software application substantially as hereinbefore described with reference to the accompanying drawings.

57. A method of allowing a first software application to access data stored in a database which is associated with a second software application substantially as hereinbefore described with reference to the accompanying drawings.
